(19) United States
(12) Patent Application Publication
(10) Pub. No.: US 2026/0288828 A1
(43) Pub. Date: Sep. 24, 2026

(54) SYSTEM

(71) Applicant: SoftBank Group Corp., Tokyo (JP)

(72) Inventor: Jin TAMURA, Tokyo (JP)

(73) Assignee: SoftBank Group Corp., Tokyo (JP)

(21) Appl. No.: 19/564,240

(22) Filed: Mar. 12, 2026

(30) Foreign Application Priority Data
Mar. 19, 2025 (JP) 2025-044893

(51) Int. Cl. G06F 16/3332; G06F 40/205; G06N 5/04; H04L 67/50; H04L 67/55

(52) U.S. Cl. CPC G06F 16/3334; G06F 40/205; G06N 5/04; H04L 67/535; H04L 67/55

(57) ABSTRACT

A system includes a processor that is configured to generate a prompt for instructing a generative artificial intelligence model to determine an importance and a necessity of an action regarding information contained in an electronic message, input the generated prompt to the generative artificial intelligence model, analyze, by using natural language processing, the information contained in the electronic message based on an output from the generative artificial intelligence model and automatically extract at least one of a deadline and a summary from the information, and visually display an analysis result based on the analysis and transmit a notification to a user.

### CROSS-REFERENCE TO RELATED APPLICATION

This application is based on and claims priority under 35 USC 119 from Japanese Patent Application No. 2025-044893 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional electronic mail and messaging systems require users to manually read, interpret, and prioritize large volumes of textual information in order to determine the importance of each message, whether a reply or other action is necessary, and whether any implicit or explicit deadline exists. As the number of incoming messages increases, users experience significant cognitive load and time consumption in triaging messages, frequently overlooking important items or failing to respond in a timely manner. Although some systems provide simple rule-based filters or static priority flags, such mechanisms are not sufficiently accurate for complex, natural-language content and do not flexibly adapt to individual user behavior or context. Furthermore, existing systems do not fully exploit generative artificial intelligence models via a simple, scalable application programming interface integration, nor do they provide an effective mechanism for automatically generating summaries and deadlines or for evolving into a personalized, machine-learning-based paid option for information search tools. Therefore, there is a need for a system that automatically analyzes message content using generative artificial intelligence and natural language processing, extracts importance, necessary actions, deadlines, and summaries, visually presents the analysis results to the user, and continuously improves accuracy and personalization through a user-specific optimization model.

### SUMMARY

In order to solve the above-described problems, the present invention provides a system comprising a processor, wherein the processor is configured to generate a prompt for instructing a generative artificial intelligence model to determine an importance and a necessity of an action regarding information contained in an electronic message, input the generated prompt to the generative artificial intelligence model, analyze, by using natural language processing, the information contained in the electronic message based on an output from the generative artificial intelligence model and automatically extract at least one of a deadline and a summary from the information, and visually display an analysis result based on the analysis and transmit a notification to a user. The processor is further configured to utilize a simplified application programming interface integration model with the generative artificial intelligence model in order to improve an accuracy of the system, thereby enabling easy deployment, maintenance, and enhancement of the analysis functions. In addition, the processor is configured to use a user-specific optimization model including custom machine learning to analyze a behavior history of the user and to support providing a paid option of an information search tool based on a result of the analysis. By these means, the system automatically performs high-precision interpretation and prioritization of messages, reduces the user's cognitive load and time required for triage, and offers personalized, monetizable advanced features for message management and information retrieval.

The term “system” refers to an arrangement of one or more hardware and/or software components that cooperate to execute the processing described in the present specification and claims.

The term “processor” refers to any hardware or combination of hardware and software, including but not limited to a central processing unit (CPU), microprocessor, microcontroller, programmable logic device, or distributed processing environment, that is configured to execute instructions for performing the functions described in the present specification and claims.

The term “generative artificial intelligence model” refers to a machine-learned model, such as a large language model or other generative model, that is capable of generating or transforming text or other data in response to an input prompt.

The term “prompt” refers to data, typically including text, that is provided as input to the generative artificial intelligence model and that instructs the generative artificial intelligence model regarding a requested task, such as determining an importance or a necessity of an action.

The term “importance” refers to a degree or level of priority assigned to information contained in an electronic message, indicating how urgently or critically the information should be addressed by a user.

The term “necessity of an action” refers to a requirement or recommendation that a user perform at least one specific operation, such as replying, approving, reviewing, or otherwise responding to information contained in an electronic message.

The term “electronic message” refers to any digital communication containing textual information, including but not limited to email messages, chat messages, notifications, and other message formats transmitted over a network.

The term “natural language processing” refers to techniques and algorithms for analyzing, interpreting, or manipulating human-readable language data, including but not limited to tokenization, parsing, entity extraction, classification, and summarization.

The term “deadline” refers to a time constraint or due date, explicitly or implicitly indicated in the information contained in an electronic message, by which an action or response is expected to be completed.

The term “summary” refers to a condensed representation of the content of an electronic message that captures at least essential points or key information in a shorter form than the original content.

The term “analysis result” refers to data derived from processing the information contained in an electronic message, including at least one of an importance, a necessity of an action, a deadline, and a summary, and optionally additional metadata.

The term “visually display” refers to presenting information on a display device, such as a monitor, smartphone screen, or graphical user interface, in a human-perceivable visual format including text, icons, colors, or other graphical elements.

The term “notification” refers to a message or signal transmitted to a user, by way of a terminal or similar device, to inform the user of at least a portion of the analysis result or to prompt the user to take an action.

The term “application programming interface integration model” refers to a design or method for enabling communication between the system and the generative artificial intelligence model via one or more defined application programming interfaces, such as web-based or network-based APIs.

The term “simplified application programming interface integration model” refers to an application programming interface integration model in which the number of required parameters, steps, or configuration elements is reduced, thereby enabling easier implementation, maintenance, and scaling of communication with the generative artificial intelligence model.

The term “accuracy of the system” refers to a degree to which the system correctly determines or estimates one or more of the importance, necessity of an action, deadline, and summary for a given electronic message, as compared with an expected or desired result.

The term “user-specific optimization model” refers to a model that is configured to adapt the behavior of the system based on data associated with an individual user, so that the system's outputs are optimized or personalized for that user.

The term “custom machine learning” refers to machine learning techniques or models that are designed, trained, or configured specifically for the system and its users, as opposed to generic or unmodified third-party models, and that are used to improve personalization or prediction based on user data.

The term “behavior history of the user” refers to data representing past interactions of the user with electronic messages and with the system, including but not limited to reading, replying, ignoring, marking, or otherwise handling messages.

The term “information search tool” refers to a function, module, or external service that allows a user to search for and retrieve information, such as messages, documents, or related data, using keywords, filters, or other search criteria.

The term “paid option” refers to a feature, service tier, or subscription offering that is available to a user upon payment of a fee and that provides enhanced or additional functionality compared with a basic or free offering.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

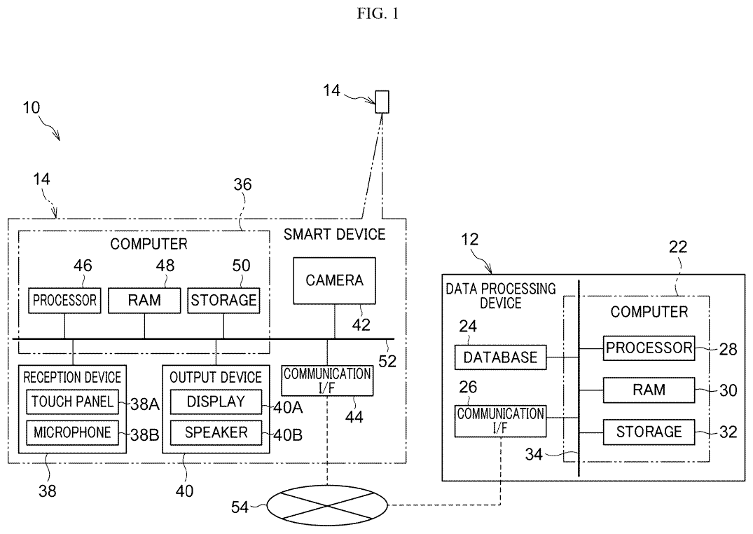

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

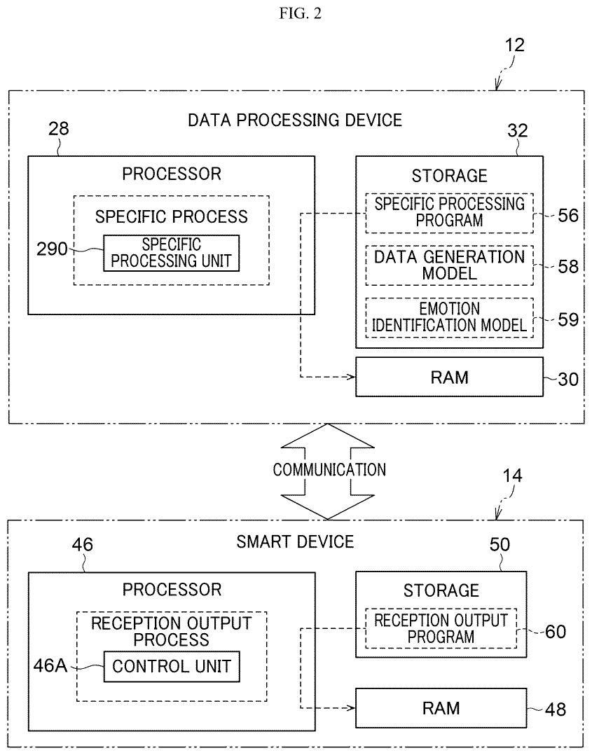

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional electronic message management systems suffer from several technical limitations in how they process, prioritize, and present large volumes of message data. In typical architectures, a server merely retrieves messages from a communication device, performs rule-based filtering or keyword matching, and forwards the raw or lightly annotated messages to a client. Such systems generally do not integrate external natural language processing services and generative artificial intelligence models in a coordinated manner, and they do not construct or maintain user-specific machine learning models that adapt scoring and ranking to individual user behavior. As a result, the server must repeatedly perform inefficient and redundant computations for each new message and for each user, leading to increased processing latency, higher consumption of computing resources, and degraded scalability when the number of messages and users increases.

Furthermore, conventional systems typically treat importance determination, action-necessity determination, deadline extraction, summarization, and search indexing as separate, loosely coupled functions. This fragmented design causes duplication of parsing and analysis steps, inconsistent metadata across components, and frequent transfers of large message payloads between modules. These factors increase memory usage, input/output overhead, and communication overhead within the system. Additionally, existing systems usually rely on fixed global rules or static models and do not systematically capture user feedback events such as viewing, responding, flagging, or removing messages as training signals. Therefore, the system cannot efficiently refine its models to improve technical performance, such as ranking accuracy and response time, based on real user behavior.

Moreover, generative artificial intelligence models are often used in an ad hoc fashion, for example, only to generate human-readable summaries on demand from a client. The server typically does not construct structured prompt sentences that are optimized to minimize token size, avoid redundant input, and elicit machine-readable outputs that can be directly stored and indexed. Consequently, such usage patterns lead to unnecessary network calls to the generative artificial intelligence model, excessive data transmission, increased processing cost, and non-deterministic output formats that are difficult for the server to integrate into downstream indexing and retrieval components.

In addition, conventional search subsystems for electronic messages commonly rely on simple full-text indices that do not incorporate dynamically maintained importance scores, action-necessity indicators, or generative summaries as first-class index fields. This lack of unified indexing prevents the system from efficiently executing complex queries combining importance conditions, deadline conditions, and action-necessity conditions, especially in a multi-tenant environment where paying and non-paying users require different levels of search capability. As a result, the search engine cannot consistently exploit machine learning outputs and generative outputs to improve retrieval precision and latency, and must often perform expensive post-processing and filtering in application logic.

Still further, typical client-side applications (terminal devices) only display conventional fields, such as subject lines and timestamps, and rely on users to open and read each message to determine its priority and required actions. This results in frequent client-server round trips, heavy rendering workloads on the terminal, and inefficient use of user interface resources. Because the client usually does not receive preprocessed importance scores, action-necessity flags, and structured deadlines from the server, the client cannot perform lightweight local operations such as sorting and filtering based on these attributes without additional server queries.

Accordingly, there is a need for an improved computer-implemented system in which a server integrates external natural language processing services, generative artificial intelligence models, and user-specific machine learning models into a unified processing pipeline that: (i) calculates and maintains normalized structured data for each electronic message; (ii) generates optimized prompt sentences and structured outputs for generative artificial intelligence models; (iii) incrementally updates user-specific models using feedback signals obtained from terminal devices; and (iv) indexes all of these machine-generated attributes in a search platform. Such a system should reduce redundant computation and network overhead, improve the efficiency and scalability of server-side processing, and enable terminal devices to render prioritized, action-focused message lists with reduced local computation and communication, thereby constituting a technical improvement in the operation of computers and computer networks that process electronic messages at scale.

The specific processing by the specific processing unit 290 of the data processing device 12 in Example 1 is realized by the following means.

The present invention provides a server comprising a processor, a storage device, a communication interface, and a search platform interface, the processor being configured to store, in the storage device, electronic message data acquired from a communication device as analysis target data; to extract sender information, subject information, body information, and time information from the analysis target data, to normalize the extracted information as structured data, and to store the structured data in the storage device; to transmit at least a part of the structured data to an external information processing service having a natural language processing function and to acquire, from the external information processing service, analysis result data including at least topic information, sentiment information, keyword information, and date-time expression information; to calculate, based on the analysis result data and the structured data, feature values including at least source attributes, linguistic expressions, sentiment indices, length indices, and classification indices, and to determine an importance score and a necessity of response or action for each piece of the electronic message data; to accumulate, in the storage device, behavior history data including at least viewing operations, response operations, storage operations, and deletion operations of a user with respect to the electronic message data; to generate or update, based on the behavior history data, a user-specific machine learning model, and to correct the importance score and the necessity of response or action for each user by using the user-specific machine learning model; to generate a prompt sentence for a generative artificial intelligence model so as to automatically extract or supplement summary information and deadline information in natural language from the analysis result data and the feature values, the prompt sentence including at least the structured data and the analysis result data; to input the prompt sentence and the electronic message data into the generative artificial intelligence model and to acquire, from the generative artificial intelligence model, response data including at least summary information, action item information, and deadline information; to register, in the search platform, search index data including the electronic message data, the corrected importance score, the corrected necessity of response or action, the deadline information, and the summary information; to provide, based on user attribute information, a basic search function using the search index data to a non-paying user and an extended search function including at least an importance condition, a deadline condition, and an action-necessity condition to a paying user; and to transmit, via the communication interface, list information including, for each piece of the electronic message data, the corrected importance score, the corrected necessity of response or action, the deadline information, and the summary information to a terminal device and to receive, from the terminal device, feedback information including at least viewing, response, flagging, or removal relating to the electronic message data as part of the behavior history data. This enables a coordinated server-side architecture in which natural language processing, generative artificial intelligence processing, user-specific machine learning, and search indexing are integrated into a single optimized pipeline, thereby reducing redundant parsing and analysis operations, minimizing network and storage overhead, improving the accuracy and stability of importance and action-necessity determinations over time, and allowing terminal devices to receive compact, pre-prioritized message representations that reduce local processing and communication load while improving overall system responsiveness and scalability.

The term “electronic message data” refers to data representing an electronic communication, including at least header information such as sender, recipient, subject, and time information, and body information containing text and optionally attachments or embedded content.

The term “communication device” refers to a computing or networking device configured to send or receive electronic messages, including but not limited to mail servers, messaging servers, or gateway devices connected to a communication network.

The term “analysis target data” refers to electronic message data that has been selected and stored for processing by the system, prior to extraction of structured fields and further analysis.

The term “storage device” refers to a hardware or virtual component configured to store data persistently or semi-persistently, including but not limited to magnetic storage, solid-state storage, and distributed storage resources.

The term “structured data” refers to data obtained by parsing and normalizing electronic message data into a predefined format, such as records or fields representing sender information, subject information, body information, and time information.

The term “sender information” refers to data identifying an originator of an electronic message, including at least an address value and optionally additional metadata such as display name or account identifier.

The term “subject information” refers to data representing a subject line or title field of an electronic message, typically used to summarize the content of the message.

The term “body information” refers to data representing the main content of an electronic message, including plain text, markup text, or other content that can be converted into text for analysis.

The term “time information” refers to data representing a time-related attribute of an electronic message, including but not limited to a sent time, a received time, or a creation time.

The term “external information processing service” refers to a remotely accessible computation resource providing analysis functions via a communication network, and not limited to any particular provider, implementation, or deployment model.

The term “natural language processing function” refers to a capability of analyzing human language text to extract semantic, syntactic, or statistical information, including but not limited to topic, sentiment, keyword, or entity information.

The term “analysis result data” refers to data generated by the natural language processing function in response to structured data or other inputs, including but not limited to topic information, sentiment information, keyword information, and date-time expression information.

The term “topic information” refers to data indicating one or more subject matters or categories associated with the content of an electronic message.

The term “sentiment information” refers to data indicating an emotional or attitudinal characteristic of an electronic message, such as polarity, intensity, or related metrics.

The term “keyword information” refers to data indicating one or more words or phrases deemed significant for describing or indexing the content of an electronic message.

The term “date-time expression information” refers to data indicating textual expressions relating to dates or times within an electronic message, such as explicit dates or relative time phrases.

The term “feature values” refers to numerical or categorical values computed from structured data and analysis result data, and used as input to a rule-based or machine learning process.

The term “source attributes” refers to feature values that characterize an origin of an electronic message, such as sender domain, sender role, or communication channel.

The term “linguistic expressions” refers to feature values derived from the language used in an electronic message, such as presence of urgency words, question forms, or specific phrases.

The term “sentiment indices” refers to numerical feature values representing one or more aspects of sentiment information, such as a sentiment score or confidence measure.

The term “length indices” refers to feature values representing a magnitude of content in an electronic message, such as a number of characters, words, or sentences.

The term “classification indices” refers to feature values indicating one or more categories assigned to an electronic message, such as business category, notification type, or automated message type.

The term “importance score” refers to a numerical value indicating a relative priority or significance assigned to an electronic message by the system.

The term “necessity of response or action” refers to an evaluation indicating whether an electronic message requires a reply, a task, or no action by a user.

The term “behavior history data” refers to data recording user interactions with electronic messages, including but not limited to viewing operations, response operations, storage operations, deletion operations, and flagging operations.

The term “user-specific machine learning model” refers to a machine learning model whose parameters or structure are trained or adapted based on behavior history data associated with a particular user.

The term “prompt sentence” refers to a text or structured representation including instructions and contextual information, configured for input to a generative artificial intelligence model to elicit a desired output.

The term “generative artificial intelligence model” refers to an artificial intelligence model configured to generate new text or other data based on input data and learned parameters, including but not limited to language models.

The term “summary information” refers to text or structured data that concisely describes main points or essential content of an electronic message.

The term “deadline information” refers to data representing a time by which a response or action related to an electronic message should be completed, obtained from explicit or implicit date-time expressions.

The term “action item information” refers to data describing one or more specific tasks or actions inferred from an electronic message as being required or recommended.

The term “response data” refers to data generated by a generative artificial intelligence model in response to a prompt sentence and input content, including at least summary information, action item information, or deadline information.

The term “search platform” refers to a software and hardware system configured to index, search, and retrieve data based on queries, including but not limited to full-text and attribute-based search functions.

The term “search index data” refers to indexed representations of electronic message data and associated attributes, stored in a form suitable for efficient retrieval by the search platform.

The term “user attribute information” refers to data describing characteristics of a user, including but not limited to subscription status, account type, and configuration preferences.

The term “basic search function” refers to a search capability that allows retrieval of electronic messages based on a limited set of criteria, such as simple keyword or field-based searches.

The term “extended search function” refers to a search capability that allows retrieval of electronic messages based on advanced criteria, including at least importance conditions, deadline conditions, and action-necessity conditions.

The term “non-paying user” refers to a user who is associated with a usage plan or account type that does not require a direct fee for search or prioritization functions.

The term “paying user” refers to a user who is associated with a usage plan or account type that requires a fee for access to extended or premium search and prioritization functions.

The term “list information” refers to data including multiple electronic messages and, for each electronic message, associated attributes such as importance scores, necessity of response or action, deadline information, and summary information.

The term “terminal device” refers to a client-side computing device configured to communicate with the server, including but not limited to mobile devices, desktop computers, and browser-based clients.

The term “feedback information” refers to data transmitted from a terminal device to the server indicating user interactions with electronic messages, including viewing, response, flagging, or removal actions.

The term “communication interface” refers to a hardware or software component that enables data exchange between the server and external devices or services via a communication network.

The term “search platform interface” refers to a component or module that enables the processor to register search index data with, and perform queries against, the search platform.

The term “user-specific optimization model” refers to a model that integrates multiple sub-models, including at least an importance determination model, an action-necessity determination model, and a search result ranking model, and that is configured based on behavior history data and user attribute information.

The term “importance determination model” refers to a model or algorithm configured to determine or refine the importance score of an electronic message based on feature values and user-specific information.

The term “action-necessity determination model” refers to a model or algorithm configured to determine whether an electronic message requires a reply, a task, or no action.

The term “search result ranking model” refers to a model or algorithm configured to determine an order in which search results corresponding to electronic messages are presented to a user.

The term “provision conditions” refers to conditions governing availability, scope, or quality of a service provided to a user, such as access to extended search functions or prioritization features.

The term “fee conditions” refers to conditions relating to charges or pricing for providing a service to a user, such as subscription levels, usage-based fees, or tiered pricing associated with search or optimization functions.

In the following embodiments, a server, a terminal, and a user cooperate to implement the claimed system. Each embodiment may be implemented alone or in combination, and variations and modifications apparent to those skilled in the art are intended to be encompassed.

### 1. Overall Hardware and Software Configuration

The server includes at least one processor, a main memory, a storage device, a communication interface, and a search platform interface. The server executes an operating system such as a general-purpose server operating system, and application software including an email ingestion module, a parsing module, a natural language processing (NLP) integration module, a machine learning (ML) engine, a generative AI integration module, a search indexing module, and an API module.

The server uses a relational database management system such as a general-purpose relational database to store structured records, and optionally a document-oriented database for JSON-structured fields. The server communicates with external NLP services and generative AI models over a packet-switched network using secure protocols such as HTTPS. The server connects to a search platform such as a full-text search engine or distributed search cluster using a search platform interface.

The terminal includes at least one processor, a memory, a display, a user input device, and a communication interface. The terminal executes an operating system such as a mobile operating system or desktop operating system, and a client application implemented for example in a mobile framework or web framework. The terminal communicates with the server over a network using protocols such as HTTPS.

The user operates the terminal to view electronic messages, issue queries, and provide feedback. The user does not directly interact with the underlying NLP or ML algorithms; instead, the user receives processed outputs generated by the server.

### 2. Data Structures and Storage

The server stores electronic message data in the storage device using a normalized schema.

The server associates each electronic message with a message identifier, a user identifier, and a mailbox identifier. The server stores raw headers, raw body, and parsed fields.

The server represents structured data as a set of fields including, for example, sender_address, sender_domain, subject_text, body_text, sent_timestamp, received_timestamp, and language_code. The server stores analysis result data as JSON documents including topic_labels, sentiment_scores, sentiment_confidences, keyword_list, and date_time_entities.

The server stores feature values for each message in a feature table including numerical and categorical fields such as:
source_importance_score (numeric),
urgency_keyword_count (numeric),
question_mark_count (numeric),
sentiment_polarity (numeric),
sentiment_magnitude (numeric),
body_length_tokens (numeric),
message_category (categorical),
sender_role_class (categorical).

The server stores behavior history data in a log table with entries containing:
user_id,
message_id,
event_type (e.g., “open”, “reply”, “flag”, “archive”, “delete”),
event_timestamp,
latency_since_receipt (numeric).

The server stores parameters of user-specific machine learning models in model parameter tables. For example, the server stores weight vectors for linear models, tree structures for gradient boosting, and neural network weights for deep models.

The server stores search index data either within the search platform or as documents prepared for indexing, containing fields such as:
indexed_subject_text,
indexed_body_text,
importance_score_personalized,
action_necessity_flag,
deadline_timestamp,
ai_summary_text,
entity_list.

### 3. Natural Language Processing Integration

The server uses software libraries and external services to perform NLP on electronic message data. In one embodiment, the server invokes a remote NLP service that provides functions for tokenization, language detection, entity recognition, sentiment analysis, and text classification. The server configures the NLP service request to include:
the subject_text and body_text as input content,
the language_code,
a set of requested analyses (e.g., entities, sentiment, categories).

The server receives analysis result data as structured JSON. The server maps recognized entities labeled as dates or times to a date_time_entities list. The server computes additional derived values, such as:
urgency_keyword_count by scanning for predefined urgency expressions,
question_mark_count by counting question mark characters or interrogative patterns,
body_length_tokens by tokenizing the body_text and counting tokens.

By centralizing NLP in a dedicated module and storing normalized analysis results, the server avoids repeated parsing and text analysis for downstream components, thereby reducing CPU utilization and memory usage. This leads to improved throughput when processing large volumes of messages.

### 4. Machine Learning Model Structures and Learning Procedures

The server implements at least two classes of machine learning models: global baseline models and user-specific optimization models.

In one embodiment, the server uses a gradient boosting decision tree model as a global importance determination model. The server trains this model offline on a training dataset that includes historical messages and labeled importance values. The feature vector includes the feature values described above.

The server minimizes a loss function such as mean squared error between predicted importance scores and labeled importance values. The server performs tree construction steps by iteratively adding trees that fit the negative gradient of the loss function, with constraints on tree depth, learning rate, and number of leaves to avoid overfitting. The server stores the resulting model parameters in the storage device.

The server also implements a logistic regression classifier or neural network as an action-necessity determination model. In one embodiment, the server uses a feedforward neural network with:
an input layer corresponding to the feature vector dimension,
one or more hidden layers using rectified linear unit (ReLU) activations,
an output layer with a softmax activation for three classes (“reply”, “task”, “none”).

The server trains this model using a cross-entropy loss function based on labeled data where each message is annotated with an action type. The server updates weights using a stochastic gradient descent algorithm or a variant such as Adam, and uses mini-batch training with regularization (e.g., L2 penalty, dropout) to stabilize convergence.

For user-specific models, the server maintains additional parameters to adjust the global outputs. In one embodiment, the server represents the user-specific importance adjustment as a linear transformation:

personalized_importance=global_importance+w_user·f_user
where w_user is a user-specific weight vector and f_user is a subset of feature values particularly relevant to the user, such as sender_domain and message_category.

The server periodically updates w_user using online learning. When the server receives feedback events (e.g., quick replies, immediate opens), the server computes an error between the predicted personalized importance and an inferred target importance derived from behavior. The server then adjusts w_user using gradient descent:

w_user(new)=w_user(old)−η∂L/∂w_user
where η is a learning rate and L is a loss function such as squared error or logistic loss. This mechanism allows the server to adapt quickly to a user's preferences without retraining the full global model.

For the user-specific optimization model used in ranking search results, the server may implement a learning-to-rank algorithm such as pairwise ranking. The server uses sequences of messages that the user has selected or opened in response to search queries to generate preference pairs. The server trains a ranking model (e.g., gradient boosted trees or neural network) to minimize a ranking loss, such as a hinge loss on the relative ordering of messages, thereby improving the accuracy of search result ordering for that user.

By explicitly defining model architectures, loss functions, and weight update procedures, the server improves computational efficiency and convergence stability compared to ad hoc heuristic scoring. The use of structured features and formal optimization reduces variance in importance and action-necessity determinations, leading to a more predictable and technically robust system.

### 5. Generative AI Model Integration and Prompt Construction

The server integrates a generative AI model, such as a large language model, as an external service accessible through a network API. The server uses the generative AI model not only to generate human-readable summaries, but to produce structured outputs that can be stored and indexed.

The server constructs a prompt sentence by combining:
the subject_text and body_text,
selected feature values (e.g., detected deadlines, importance hints),
explicit instructions for format and content.

In one embodiment, the server constructs an instruction-style prompt in natural language, such as:

“The following is an email received by a business user. Analyze it and perform these tasks:
1) Rate the importance on a scale from 0 to 100.
2) State clearly whether a reply is required, a task (action) is required, or no action is required.
3) Extract any explicit or implicit deadlines as a concrete date if possible.
4) Generate a concise summary (maximum 40 words) focusing on what the user must know and do.
Return your answer in the following form:
importance_score: [number]
action_type: [‘reply’, ‘task’, or ‘none’]
deadline: [ISO 8601 date or ‘none’]
summary: [text]
Email subject: [subject text]
Email body: [body text]”

In another embodiment, when the user explicitly interacts with the AI via the terminal, the server uses a prompt sentence of the form:

“Based on the following email, please summarize the main points in 3 bullet points and clearly list the actions I need to take and by when. Use simple language.
Email subject: [subject text]
Email body: [body text]”

The server sets model parameters, such as a low temperature value, to reduce randomness and ensure stable outputs. The server parses the returned text to extract the requested fields.

Because the server supplies a constrained instruction and format, the server can reliably parse the generative AI output with simple string operations or pattern matching, avoiding heavy post-processing.

The specific design of the prompt sentence reduces the amount of text that must be transmitted to the generative AI model, thereby reducing network load and token-based computational cost. By including only necessary fields and compressing instructions into a concise format, the server reduces latency and improves throughput. The server also uses intermediate feature values from the NLP module to pre-normalize date-time expressions, allowing the generative AI model to refine deadlines with less ambiguity and fewer tokens.

### 6. Search Indexing and Retrieval Mechanisms

The server registers search index data in a search platform using a structured schema. The server defines fields for:
primary content (subject, body),
numeric scores (importance_score, personalized_importance_score),
categorical flags (action_required, action_type),
temporal attributes (deadline_timestamp, sent_timestamp),
generated text (ai_summary_text),
entities (persons, organizations, dates).

The server configures the search platform to index numeric fields with appropriate data types, enabling range queries, and to index text fields with tokenization and analyzers tuned for email content. The server uses inverted indices and numeric trees within the search platform to support efficient queries.

When a query is issued, the server submits a compound query to the search platform, including:
text search conditions (keywords, phrases),
filter conditions on importance ranges,
filter conditions on deadlines (e.g., before a certain date),
filter conditions on action_necessity.

The search platform returns candidate messages with basic relevance scores. The server then applies the user-specific optimization model to re-rank these candidates based on the user's historical preferences and behavior. The server computes an adjusted ranking score as a combination of the search platform score and the model's output. This two-stage retrieval and ranking architecture improves precision and recall while constraining computational complexity, because the expensive ML ranking model operates only on a reduced candidate set.

The extended search function is made available to paying users by allowing more complex filter expressions and by enabling the user-specific ranking stage. For non-paying users, the server bypasses or limits these features, executing simpler queries and default sorting. This separation allows the server to allocate more computational resources to users who require advanced capabilities.

### 7. Terminal Behavior and User Interaction

The terminal requests list information from the server and receives, for each message, the personalized importance score, action-necessity flag, deadline, and AI-generated summary.

The terminal stores this list in a local cache, for example in an in-memory data structure or a lightweight local database.

The terminal uses the local cache to sort and filter messages without repeatedly querying the server. For example, the terminal sorts messages by personalized importance score and filters to show only messages with deadlines within a given period. Because the server has already computed these attributes, the terminal performs only simple numerical comparisons and text displays, thereby reducing client CPU load and network round trips.

The terminal displays visual identifiers, such as colored indicators or icons, based on discrete buckets of the importance score and action-necessity flag. The terminal also displays deadlines in a user's local time zone and the AI-generated summary under each subject line. When the user selects a message, the terminal retrieves the full message content from the server or from its cache.

The user may invoke a generative AI assistance function in the terminal. The terminal then transmits the user's natural-language question together with the message identifier to the server. The server retrieves the associated message content and constructs a new prompt sentence including the user's question. The server sends this to the generative AI model and returns the answer to the terminal, which displays it in a conversational interface.

By leveraging precomputed scores and summaries from the server, the terminal reduces display latency and avoids performing heavy NLP or ML computations locally. This leads to improved battery life on mobile devices and reduced bandwidth consumption, which are concrete technical advantages.

### 8. Technical Effects and Improvement of Computer Technology

The server implements a unified, structured pipeline that combines NLP, ML, and generative AI processing in a technically coordinated manner. The server reduces redundant parsing and analysis by:
performing text parsing once and storing structured data,
invoking external NLP services in batched or cached requests,
using precomputed feature values across multiple models and components.

As a consequence, the server requires fewer CPU cycles per message and achieves lower average processing latency. The normalized data structures also reduce memory fragmentation and simplify caching strategies, leading to better utilization of storage and memory.

The use of user-specific optimization models and online learning directly improves computational efficiency and accuracy. By adapting weights based on behavior history, the server converges to a configuration that minimizes unnecessary alerts and misclassifications.

This reduces the number of corrective actions that need to be processed and stored, thereby decreasing write operations to the database and message reprocessing.

The server's careful design of prompt sentences and controlled integration with a generative AI model results in reduced network and computation costs for the generative AI component.

The server transmits only essential text components and structured instructions, avoiding redundant context. This design reduces the number of tokens processed by the generative AI model and shortens response times, which is a direct improvement in computing efficiency for AI-powered services.

The specific data structures and algorithms used for indexing and ranking enable efficient multi-criteria search. By indexing importance scores, deadlines, and AI summaries as first-class fields, the search platform can execute complex queries without expensive application-side scanning or filtering. The user-specific ranking model operates only on a small set of candidate messages returned by the search platform, significantly reducing the number of scoring operations compared to a naive approach that scores all messages.

The combination of these techniques yields a system that is not merely automating a human workflow, but changing and improving the way in which computers store, process, and retrieve electronic message data. The improvement is manifested in measurable system-level metrics, such as increased throughput, reduced latency, lowered CPU and memory utilization, and improved ranking accuracy of important messages. Additionally, the structured and optimized use of generative AI outputs as machine-readable fields enables new forms of indexing and retrieval that were not technically feasible with traditional rule-based systems.

### 9. Alternative Embodiments and Variations

In one alternative embodiment, the server uses a different neural network architecture for importance prediction, such as a recurrent neural network or transformer-based encoder that directly ingests tokenized subject and body text in addition to engineered feature values. The server trains such models using backpropagation through time or attention-based gradient descent, while still storing the resulting importance scores and action-necessity flags in the same data structures.

In another embodiment, the server applies data augmentation techniques to the training dataset, such as paraphrasing message text, injecting synthetic urgency patterns, or adding noise to timestamps, to increase robustness. The server modifies loss functions to incorporate penalties for misclassifying urgent messages, thereby biasing the model towards minimizing false negatives with respect to important communications.

In a further embodiment, the server incorporates hardware acceleration for ML inference, such as graphical processing units or dedicated accelerators. The server offloads heavy computations for neural networks to such hardware, which reduces wall-clock processing time for scoring and ranking.

In yet another embodiment, the server combines multiple generative AI prompts into a pipeline, first requesting a normalized JSON-like structure, and then requesting a shorter user-facing summary based on that structure. The server thereby reduces parsing complexity and creates more stable indices for search.

In all of these embodiments, the server, the terminal, and the user cooperate through defined interfaces and data structures. The server executes computationally intensive and structurally complex operations; the terminal performs lightweight presentation and interaction tasks; and the user benefits from improved prioritization and navigation of electronic messages. The overall system architecture and processing flows therefore constitute an improvement in computer functionality, particularly in the domain of large-scale electronic message management using a generative AI model and structured prompt sentences.

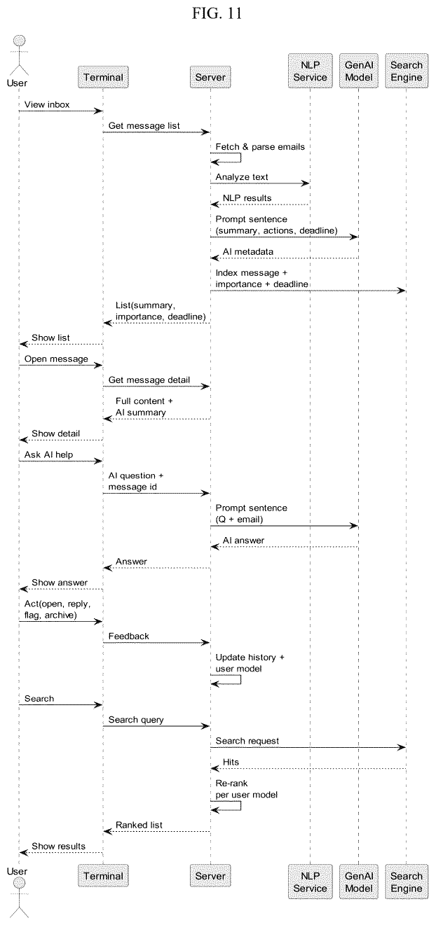

The following describes the processing flow using FIG. 11.

### Step 1:

The server acquires raw electronic message data from a communication device.

The server receives, as input, new electronic messages from a mail server or messaging server via a communication protocol such as IMAP or a web API. The input includes raw headers (sender, recipient, subject, timestamps) and raw body content (plain text or HTML). The server performs a data acquisition operation by issuing fetch commands or API calls, authenticating the user, and downloading the message content. The server then writes the raw electronic message data into a storage device, associating each message with a unique message identifier and a user identifier. The output of this step is stored raw electronic message data marked as analysis target data.

### Step 2:

The server parses the analysis target data and generates structured data.

The server reads, as input, the raw electronic message data from the storage device. The server uses a parsing library to separate header fields and body content and to decode character encodings. The server extracts specific fields such as sender address, sender domain, subject text, body text, sent timestamp, and received timestamp. The server converts timestamps into a normalized time format, such as UTC in ISO 8601 representation, and normalizes textual encodings to a standard, such as UTF-8. The server stores these normalized values in a structured record or JSON document. The output of this step is structured data representing each message in a unified schema.

### Step 3:

The server performs natural language processing on the structured data.

The server uses, as input, the subject text, body text, and language code contained in the structured data. The server constructs a request payload and transmits the text to an external natural language processing service via a network interface. The server requests operations such as tokenization, language detection, entity recognition, sentiment analysis, and category classification. The server receives a response including topic labels, sentiment scores, sentiment confidences, keyword lists, and detected date-time expressions. The server stores these analysis result data objects in association with the corresponding message identifiers. The output of this step is analysis result data describing the linguistic and semantic properties of the message text.

### Step 4:

The server computes feature values from the structured data and the analysis result data. The server takes, as input, the structured data fields and the analysis result data for each message. The server executes deterministic feature extraction routines that count occurrences of urgency expressions, interrogative markers, and domain-specific keywords. The server calculates numerical values such as body length in characters or tokens, normalized sentiment polarity, sentiment magnitude, and counts of entities of particular types. The server also derives categorical indicators, such as message category and sender role class, based on predefined mappings. The server writes these numerical and categorical feature values into a feature table. The output of this step is a feature vector for each message.

### Step 5:

The server determines a global importance score and a global action-necessity classification. The server uses, as input, the feature vector of each message. The server loads a pre-trained global importance determination model, such as a gradient boosted decision tree model, and passes the feature vector through this model to compute a predicted importance score. The server also loads a global action-necessity determination model, such as a neural network classifier, and supplies the same or extended feature vector to obtain class probabilities for “reply”, “task”, or “none”. The server converts these probabilities into a discrete action type and a boolean action-required flag. The server stores the global importance score and the action-necessity classification with the corresponding message records. The output of this step is a global importance score and an action-necessity label for each message.

### Step 6:

The server updates and applies a user-specific optimization model.

The server reads, as input, the global importance score, the action-necessity label, and the behavior history data for the user. The server aggregates behavior events, such as rapid opens and quick replies, to infer an implicit target importance level for past messages. The server computes an error value between predicted global importance scores and inferred targets and updates user-specific weights using an online learning algorithm, such as stochastic gradient descent. The server then applies the updated user-specific model to new messages, using a linear or non-linear transformation of selected features and the global score to produce a personalized importance score and possibly to adjust the action-necessity label. The output of this step is a personalized importance score and, optionally, a personalized action-necessity decision per message.

### Step 7:

The server extracts and normalizes deadline information.

The server takes, as input, the analysis result data and the structured body text. The server isolates entity mentions classified as dates or times and passes them to a date-time parsing module. The server interprets relative expressions, such as “next Friday” or “in three days,” using the message sent timestamp as a reference. The server converts these expressions into concrete timestamps in a normalized time zone and format. If multiple candidate deadlines are detected, the server applies heuristic or rule-based selection, such as prioritizing the earliest future deadline. The server stores the resulting deadline timestamp and sets a flag indicating whether a valid deadline exists. The output of this step is deadline information, including a normalized deadline timestamp for each message that contains a recognizable time constraint.

### Step 8:

The server constructs a prompt sentence for a generative AI model.

The server uses, as input, the subject text, body text, key feature values (such as global or personalized importance hints and deadline candidates), and extracted entities. The server composes a natural-language instruction that describes the required analysis and the desired output format. The server embeds the subject and body texts after the instructions and inserts markers for sections such as “importance_score”, “action_type”, “deadline”, and “summary”. The server may truncate or condense the body text to limit the length. The output of this step is a prompt sentence configured for input to a generative AI model.

### Step 9:

The server obtains refined importance, actions, and summary from the generative AI model.

The server sends, as input, the constructed prompt sentence and corresponding message content to the generative AI model via an API. The server sets parameters such as temperature and maximum output length in the request. The server receives a textual response that follows the instructed format, including an importance score statement, an action type statement, a deadline expression, and a short summary. The server parses the returned text, extracting numeric or categorical values and converting any refined deadline expression back into a normalized timestamp using the same date-time parsing module. The server stores the AI-generated summary, the AI-suggested action items, and any refined importance or deadline values. The output of this step is AI-enhanced metadata for each message, including summary information and action item information.

### Step 10:

The server generates list information and transmits it to the terminal.

The server takes, as input, all processed attributes for each message, including personalized importance score, action-necessity flag, deadline information, and AI-generated summary.

The server selects a subset of messages, for example the most recent or most important, and organizes them into a list structure. The server serializes this list into a response format, such as a JSON document, and includes for each message the identifier, subject, personalized importance score, action-required indicator, formatted deadline string, and summary text. The server sends this response over the communication interface to the terminal. The output of this step is list information delivered to the terminal for display.

### Step 11:

The terminal presents prioritized message information to the user.

The terminal receives, as input, the list information from the server. The terminal parses the response and stores message entries in a local memory structure. The terminal converts numeric importance scores into visual indicators, such as color codes or labels, and maps the action-required flag to icons or markers. The terminal converts the deadline timestamps into local time strings and arranges them for display. The terminal renders a list view on the display, showing for each message the subject, personalized importance level, action icon, deadline, and AI-generated summary in a compact layout. The output of this step is a graphical user interface that enables the user to see prioritized messages without opening each one.

### Step 12:

The user selects messages and optionally requests AI assistance.

The user views, as input, the graphical list presented by the terminal. The user selects individual messages by tapping, clicking, or otherwise activating list entries. The user may open a message to read its full content or may press a control labeled for AI assistance to request further explanation. The user may also perform actions such as replying, flagging, or archiving from the same interface. The output of this step is a set of user actions and, optionally, a text query for AI assistance initiated from the terminal.

### Step 13:

The terminal sends user actions and feedback to the server.

The terminal gathers, as input, user interactions including message opens, replies, flags, removals, and AI-assistance requests. The terminal records the message identifiers, event types, and timestamps. The terminal packages these as feedback events in a request payload and transmits the payload to the server via the communication interface. For an AI-assistance request, the terminal includes the user's natural-language question text and the corresponding message identifier. The output of this step is feedback information and optional AI queries delivered to the server.

### Step 14:

The server updates behavior history and user-specific models based on feedback.

The server accepts, as input, the feedback information from the terminal. The server writes each event into the behavior history log, including user identifier, message identifier, event type, and timing information. The server aggregates new events and periodically recalculates user-specific model parameters using the online learning procedures described previously.

The server computes gradients of an error function that compares predicted importance or action necessity against behavior-implied targets, and updates user-specific weights accordingly. The server then uses the updated model parameters for subsequent messages processed for that user. The output of this step is refined user-specific models that adjust future personalized importance scores and action-necessity decisions.

### Step 15:

The server processes user AI-assistance queries using additional prompt sentences.

The server receives, as input, the user's natural-language question and the associated message identifier from the terminal. The server retrieves the corresponding message content and existing metadata. The server constructs a new prompt sentence that includes the user's question followed by the subject and body of the message. The server specifies instructions such as “Explain in simple terms what actions are required and by when.” The server sends this prompt sentence to the generative AI model and receives a detailed answer. The server returns the answer text to the terminal. The output of this step is an AI-generated explanation or guidance tailored to the user's question.

### Step 16:

The terminal displays AI-generated explanations to the user.

The terminal uses, as input, the answer text returned by the server. The terminal renders the user's question and the AI-generated answer in a conversational or pane-based interface. The terminal may allow the user to scroll, copy, or initiate further queries based on the same message. The output of this step is an interactive display that enables the user to understand the content and required actions for the selected message more deeply.

### Step 17:

The server indexes messages and associated metadata for search.

The server reads, as input, the structured data, feature values, personalized importance scores, action-necessity labels, deadlines, and AI-generated summaries for each message. The server constructs search index documents containing fields for message content, numeric scores, flags, and temporal attributes. The server sends these documents to the search platform for indexing. The search platform updates its inverted indices and numeric indices to reflect the new or changed documents. The output of this step is updated search index data that support efficient retrieval based on content and machine-derived attributes.

### Step 18:

The server responds to search queries with user-optimized results.

The server accepts, as input, search queries from a terminal or another client. The queries may include keywords, importance thresholds, deadline ranges, and action-necessity conditions.

The server forwards the query to the search platform, which returns a set of candidate messages with relevance scores. The server then applies the user-specific ranking model to these candidates, computing adjusted scores that incorporate user preferences. The server sorts the messages by adjusted scores and packages them in a response payload with associated metadata. The server sends this payload to the requesting terminal. The output of this step is a ranked list of messages that reflects both search relevance and user-specific importance, delivered to the client for presentation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic messaging systems and notification systems typically treat incoming electronic messages in a uniform manner, relying on simple rule-based filters, keyword searches, or static priority flags. Such systems are limited in their ability to accurately distinguish between messages that demand immediate user action and messages of lower relevance, particularly in environments involving a large volume of transaction-related communications. As a result, users are required to repeatedly open and read full message contents, which increases cognitive load, leads to missed deadlines, and consumes excessive processing resources on both client and server sides.

Furthermore, existing integrations between messaging platforms and machine learning components often operate on unstructured outputs, requiring additional ad hoc parsing logic and brittle heuristics. This results in inefficiencies and error-prone processing paths, such as frequent format mismatches and failures to reliably extract structured attributes like importance, required action type, or deadline. The lack of a tightly defined interaction pattern between message analysis components and downstream notification logic impedes automation and reduces system robustness.

In addition, typical systems do not provide a mechanism to dynamically adapt prioritization logic based on long-term user behavior. Static scoring functions cannot adequately reflect user-specific preferences, such as which types of actions or senders the user tends to treat as urgent, or how the user reacts to different categories of deadlines. Consequently, the system cannot effectively focus computational and user attention resources on the most impactful messages in a personalized manner.

There is therefore a need for a computer-implemented technique that improves the technical functioning of messaging and notification systems by: (i) converting raw electronic message data into structured data suitable for automated processing; (ii) using a generative AI model through a precisely constructed prompt sentence with a machine-readable output specification to obtain reliably structured analysis results; (iii) computing and adjusting priority indicators based on both content-derived attributes and temporal context; and (iv) optionally refining the prioritization model using user behavior data. Such a technique should reduce processing overhead, increase reliability of automated prioritization, and improve the efficiency of user interaction with electronic messaging systems.

The specific processing by the specific processing unit 290 of the data processing device 12 in Application Example 1 is realized by the following means.

The present invention provides a server comprising a processor and a communication interface, the processor being configured to acquire electronic communication message data via the communication interface from a message storage unit, to extract structured information including sender information, subject information, body text information, and transmission time information from the electronic communication message data, to generate, on the basis of the structured information, a prompt sentence that instructs a generative AI model to determine an importance level of the electronic communication message, a necessity of a response or another action with respect to the electronic communication message, a deadline related to the electronic communication message, and a summary of the electronic communication message, to explicitly specify, within the prompt sentence, that an analysis result be output in a machine-readable structured format, and to input the prompt sentence to the generative AI model via an application programming interface, the processor being further configured to obtain the analysis result output from the generative AI model in response to the prompt sentence, to mechanically interpret the analysis result as structured data including importance information, response-or-action necessity information, deadline information, and summary information, to convert at least the importance information and the response-or-action necessity information into numerical indicators to calculate a priority indicator for the electronic communication message, to correct the priority indicator on the basis of the deadline information and current time information to determine a final priority for the electronic communication message, to generate, on the basis of the final priority, the summary information, the deadline information, and the response-or-action necessity information, a notification message, and to cause the notification message to be transmitted, via a notification delivery service over a network, to a user terminal such that the user terminal displays the notification message as visual information that enables a user to activate display of the corresponding electronic communication message or execute a related process. This enables an improved computer-implemented messaging and notification system that automatically transforms unstructured message data into structured priority information using a generative AI model with a defined prompt sentence and output format, reduces processing errors and parsing overhead, dynamically prioritizes messages based on content and temporal context, and thereby enhances the efficiency and reliability of user interaction with large volumes of electronic communications.

The term “processor” refers to a hardware computation unit, such as a central processing unit or a specialized processing circuit, that executes instructions to perform data processing operations as described in the present specification.

The term “communication interface” refers to a hardware and/or software component that enables the server to transmit and receive data over a communication network, including but not limited to wired or wireless interfaces implementing standardized communication protocols.

The term “electronic communication message” refers to a digitally represented message transmitted over a communication network, including but not limited to electronic mail, instant messages, or other text-based digital communications.

The term “message storage unit” refers to a logical or physical data storage resource, such as a message server or a database system, that stores electronic communication messages for later retrieval and processing.

The term “electronic communication message data” refers to raw or encoded data representing an electronic communication message, including header information, body content, and associated metadata.

The term “structured information” refers to data that has been organized into predefined fields or attributes, such as sender, subject, body text, and transmission time, in a format suitable for deterministic machine processing.

The term “sender information” refers to a data element that identifies an originator of an electronic communication message, such as an address, account identifier, or name field contained in the message data.

The term “subject information” refers to a data element that represents a title or topic of an electronic communication message, such as a subject line or equivalent header field.

The term “body text information” refers to textual content of an electronic communication message excluding header fields, including any main message text obtained from plain text or converted from a structured markup representation.

The term “transmission time information” refers to data indicating a time at which an electronic communication message was transmitted or made available by a message storage unit, including timestamps expressed in a standardized time format.

The term “prompt sentence” refers to a machine-generated natural language instruction or set of instructions that is provided as input to a generative AI model to request specific analytical operations and a defined output structure.

The term “generative AI model” refers to a parameterized computational model, such as a neural network, configured to generate output data in response to input data, including natural-language analysis results, based on training with large-scale datasets.

The term “importance level” refers to a classification value indicating a degree of priority or relevance assigned to an electronic communication message relative to other messages, derived from analysis of message content and metadata.

The term “necessity of a response or another action” refers to an indication of whether a user is expected or recommended to perform a specific operation, such as replying, making a payment, or submitting information, in connection with an electronic communication message.

The term “deadline” refers to time-related information indicating a due date or time limit by which a response or another action associated with an electronic communication message should be completed.

The term “summary” refers to a condensed representation of the semantic content of an electronic communication message, expressed as a shorter text that preserves key information for rapid user understanding.

The term “analysis result” refers to output data generated by the generative AI model in response to the prompt sentence, including determinations such as importance, required action, deadline, and summary.

The term “machine-readable structured format” refers to an output representation, such as a key-value structure or markup format, that can be deterministically parsed and interpreted by a computing device without human intervention.

The term “importance information” refers to a part of the analysis result that specifically represents the importance level assigned to an electronic communication message.

The term “response-or-action necessity information” refers to a part of the analysis result that specifically represents whether and what kind of response or other action is needed for an electronic communication message.

The term “deadline information” refers to a part of the analysis result that specifically represents a time or time range by which a response or action related to an electronic communication message should occur.

The term “summary information” refers to a part of the analysis result that specifically represents the summary of the content of an electronic communication message.

The term “numerical indicator” refers to a numerical value, such as an integer or real number, that represents a quantification of a qualitative attribute, including but not limited to importance or action necessity.

The term “priority indicator” refers to a numerical or ordinal value computed from at least importance information and response-or-action necessity information that represents an initial priority of an electronic communication message.

The term “final priority” refers to a refined priority value for an electronic communication message that is obtained by correcting or adjusting a priority indicator based on additional factors, including deadline information and current time information.

The term “current time information” refers to time data indicating a present or reference time obtained by the server or another time source at the moment of priority calculation or correction.

The term “notification message” refers to data generated by the server that is configured to be delivered to a user terminal and to present information related to an electronic communication message, including at least a portion of the analysis result and/or priority information.

The term “notification delivery service” refers to a network-based service or subsystem that transmits notification messages from the server to user terminals using a defined communication protocol and addressing scheme.

The term “network” refers to a communication infrastructure, including wired or wireless links, that enables data transmission between the server, the message storage unit, the notification delivery service, and user terminals.

The term “user terminal” refers to a computing device operated by a user, such as a mobile device, a handheld device, or a client computer, that is capable of receiving, displaying, and interacting with notification messages.

The term “visual information” refers to information presented on a display device in a form perceivable by a user, including text, icons, and graphical elements that represent the content of notification messages.

The term “related process” refers to a software-controlled operation that is triggered in association with an electronic communication message, including but not limited to opening the message, initiating a reply, starting a transaction, or launching another application.

The term “standardized application programming interface” refers to a defined set of communication rules, methods, and data formats that enables programmatic interaction between the server and the generative AI model in a consistent and implementation-independent manner.

The term “operation history information” refers to data recording user interactions with messages or notifications, including actions such as opening, ignoring, replying to, or performing other operations on electronic communication messages.

The term “completed action information” refers to data indicating that a user or an associated system has completed a task or transaction related to an electronic communication message, such as making a payment or submitting required documents.

The term “individual optimization learning model” refers to a machine learning model that is configured to adapt parameters based on behavior data of a particular user in order to adjust message prioritization in a user-specific manner.

The term “weighting parameters” refers to numerical factors within a model that determine the relative influence of different attributes, such as importance level, action type, or deadline proximity, on a calculated priority value.

In one embodiment, a server, a terminal, and a user cooperate to implement the invention. The server is implemented as a computing device such as a rack-mounted computer or a virtual machine executing on a cloud computing infrastructure. The server includes at least one processor, a memory, a communication interface, and a non-transitory storage medium storing a program. The terminal is implemented as a mobile computing device, such as a smartphone or tablet, including a display unit, an input unit, a wireless communication interface, and a local storage unit. The user operates the terminal to view notifications and to access electronic communication messages.

The server executes an operating system such as a general-purpose server operating system (for example, a UNIX-based system) and installs a runtime environment such as a virtual machine or an interpreter (for example, a Java virtual machine or a Python interpreter). The server further installs a mail access library such as an IMAP client library or a messaging API, an email parsing library such as a MIME parser, a hypertext markup parsing component such as an HTML-to-text converter, a network communication library for HTTP/HTTPS, and a client library for a generative AI model service. The server also installs an application framework such as a web application framework that coordinates modules for message acquisition, analysis, scoring, and notification generation.

The server uses the communication interface to connect to a message storage unit, such as a remote mail server or messaging database, via a network. The server obtains electronic communication message data including headers and message bodies. The server stores the obtained message data in the memory and in a structured form in the non-transitory storage medium, for example in a relational database or a key-value store. The server applies the email parsing library to each electronic communication message to extract structured information fields including sender information, subject information, body text information, and transmission time information. When the message body is in a markup format, the server uses the hypertext markup parsing component to remove markup tags and normalize the text into a plain-text representation.

The server constructs a specific internal data structure for each message. In one embodiment, the server creates a record that includes at least a message identifier, a sender field, a subject field, a body text field, a transmission time field, and auxiliary metadata. The server assigns a normalized character encoding (for example, UTF-8) to all text fields and removes control characters and unnecessary whitespace. This structured information is stored in a database table or document store, enabling indexed queries by sender, subject, time, and other attributes. As a result, downstream processing modules can access the message content without re-parsing the original raw format, which reduces redundant computation and improves data management efficiency.

The server prepares a prompt sentence for a generative AI model on the basis of the structured information. The server does not simply forward the body text but constructs a composite text including a task description, constraints, and a machine-readable output specification. In one embodiment, the server generates a prompt sentence in the following form:

“You are an assistant that classifies and summarizes electronic messages related to transactions. Using the information below, perform the following tasks:
1. Determine the importance level of the message as ‘high’, ‘medium’, or ‘low’.
2. Determine whether the user must perform an action; if an action is required, specify the action type in one word such as ‘payment’, ‘reply’, or ‘document’.
3. Extract any explicit deadline date or time from the message; if there is no explicit deadline, infer a reasonable deadline or output ‘none’.
4. Provide a concise summary of the message in one sentence, no longer than 40 words.

Output the result in the following structured format:
importance: <high|medium|low>
action_required: <none|payment|reply|document|other>
deadline: <YYYY-MM-DD or ‘none’>
summary: <one-sentence summary>
Sender:
[insert sender information]
Subject:
[insert subject information]
Body:
[insert body text information]
Sent at:
[insert transmission time information]”

The server inserts values of sender information, subject information, body text information, and transmission time information into the placeholders of the prompt sentence. The prompt sentence is created as a single text string and is stored temporarily in memory. The server thereby imposes a non-conventional constraint on the generative AI model: the output must follow a line-oriented, machine-readable key-value format, not a free-form narrative. This structural constraint reduces ambiguity and enables deterministic parsing, which improves computational reliability relative to systems that rely on unstructured natural language outputs.

The server communicates with the generative AI model via a standardized application programming interface. In one embodiment, the server acts as an HTTP/HTTPS client and sends a request to a generative AI model endpoint that exposes a text generation interface.

The server uses a generative AI model configured as a multi-layer neural network, such as a transformer-based language model. The model comprises an embedding layer that maps each token to a dense vector, a plurality of self-attention layers with multiple attention heads, feed-forward networks within each layer, and a final projection layer that maps model states to token probabilities. The model parameters include at least a token embedding matrix, attention weight matrices, and layer normalization parameters, all learned from large-scale text data.

The generative AI model has been trained using a gradient-based optimization algorithm, such as stochastic gradient descent with adaptive learning rate techniques. The training procedure uses a loss function that combines cross-entropy loss on the predicted tokens with regularization terms. During training, the model updates weights by backpropagation and computes gradients with respect to the loss function. The training dataset includes a variety of message-like texts, deadlines, and action descriptors, so that the model implicitly learns associations between linguistic patterns and semantic attributes such as urgency, importance, and action type. In some embodiments, the server can fine-tune the model using a smaller corpus of transaction-related messages, using supervised learning signals that specify importance labels, action types, deadlines, and summaries. The server stores fine-tuning metadata in the non-transitory storage medium.

The server sends the constructed prompt sentence to the generative AI model, specifying parameters such as maximum output length and temperature. The generative AI model executes its internal inference algorithm, which includes iteratively computing attention scores over the prompt tokens, propagating activations through the transformer layers, and sampling or selecting next tokens according to the model's learned probability distribution.

Unlike a simple keyword or rule-based system, the generative AI model evaluates a high-dimensional representation of the entire message, considering contextual relationships among words and phrases. The model can detect implicit deadlines expressed in relative terms (for example, “tomorrow” or “within two days”) by interpreting them in the context of the transmission time information presented in the prompt.

The server receives the model's generated text as a response. The server interprets this response as structured data by parsing line breaks and detecting patterns in the form “key: value”. By constraining the generative AI model to output a deterministic structure, the server avoids conventional fragile natural language parsing techniques and instead relies on a predictable format. This design improves the technical functioning of the system by reducing parsing errors, increasing processing speed, and simplifying error handling logic. The server stores the parsed analysis result in a dedicated database table linked to the underlying message record.

In one embodiment, the server maps importance text labels to numerical indicators. For example, the server assigns a numerical score of 3 to “high”, 2 to “medium”, and 1 to “low”. The server also maps action types to numerical values, for example 0 for “none”, 2 for “reply”, 3 for “document”, and 4 for “payment”. The server combines these indicators using a predefined formula such as:

priority_indicator=importance_score×α+action_score×β,
where α and β are weighting parameters stored in a configuration storage unit. The server can also incorporate other features, such as the length of the body text or the presence of specific linguistic patterns, by mapping them to additional numerical values and integrating them into the formula. The server then adjusts the priority indicator using deadline information. If the deadline is imminent relative to current time information obtained from a system clock or a time synchronization service, the server increases the priority indicator by a function that decreases as the remaining time grows. As a result, messages with earlier deadlines are automatically assigned higher priority even when importance labels are similar.

The server computes a final priority for each electronic communication message based on the corrected priority indicator. The server stores the final priority together with the message identifier and summary information in an indexable data structure. The server can maintain an ordered list or priority queue of messages, which enables efficient retrieval of the highest-priority notifications with reduced computational overhead compared to repeated full scans of all messages.

In some embodiments, the server uses an individual optimization learning model to refine weighting parameters based on user behavior. The server collects operation history information, including whether the user opened a notification, ignored it, opened the corresponding message, or executed an associated action. The server also collects completed action information, such as the occurrence of a reply or a completion record from an external system. The server uses this behavior data as input features to a secondary machine learning model, such as a logistic regression model, a shallow neural network, or a gradient-boosted decision tree model, which predicts a utility score for combinations of importance labels, action types, senders, and deadlines. The server uses a loss function that measures the deviation between predicted utility and observed user behavior, and updates weighting parameters by gradient descent or another optimization method. The server then updates α, β, and additional parameters in the priority computation formula, so that the priority indicator more accurately predicts which messages the user treats as urgent. This feedback loop improves computational efficiency by concentrating processing resources and network bandwidth on messages that statistically cause user interaction.

The server generates a notification message containing at least final priority, summary information, deadline information, and response-or-action necessity information. The server formats the notification message into a compact payload that fits the requirements of a notification delivery service. For example, the server may generate a short title line including the action type and deadline, and a body line including the summary and importance level.

The server uses a network communication library to send the notification message to a notification delivery service endpoint. The server includes a device identifier corresponding to the terminal, and includes additional data fields that allow the terminal to reference the underlying message identifier.

The server's notification payload is designed to reduce network traffic and processing load. The server does not transmit the full body text of the electronic communication message in the notification payload. Instead, the server transmits only the summary information and key attributes, which reduces the size of each notification and lowers communication load. When the user chooses to open the full message, the terminal or a client application requests the detailed content on demand. This architecture improves real-time performance and reduces unnecessary data transfer.

The terminal receives the notification message from the notification delivery service. The terminal uses its operating system's notification framework to present visual information including the title and the summary. The terminal stores the received payload in a local data structure and associates it with a local identifier. When the user selects the notification on the terminal, the terminal transmits a request to the server or to a mail client application to retrieve and display the full electronic communication message corresponding to the message identifier. The terminal thereby provides a two-stage access pattern: first, lightweight viewing of an AI-generated summary and attributes, and second, full detail retrieval on user demand.

This approach reduces unnecessary rendering of heavy message content and improves energy efficiency on the terminal side.

The user views the notification on the display unit of the terminal. The user can recognize, at a glance, an importance indication, an action type, and a deadline, without reading the entire message text. In response, the user decides whether to open the full message, initiate a reply, or start an external transaction process, such as a payment operation through a separate application. Because the server has already performed structured prioritization and summarization, the user can filter and respond to messages more efficiently than with conventional chronological or simple keyword-based notification lists.

The server architecture and algorithmic design provide technical improvements beyond mere automation of human judgment. The server uses a generative AI model with a constrained prompt sentence and a defined output format to produce structured, machine-readable attributes in a single pass. This avoids multiple passes of rule-based parsing and reduces computational complexity. The combination of structured prompt design, numerical scoring, deadline-aware correction, and individualized weighting yields a non-traditional data processing pipeline that improves accuracy and robustness of message prioritization under high message volume. The reduced ambiguity in AI outputs also lowers error rates in downstream modules and diminishes the need for manual error correction or fallback routines. In another embodiment, the server employs a locally hosted generative AI model executing on specialized hardware, such as a processor with vector acceleration or a graphics processing unit. The server can load a transformer-based language model into memory and perform inference locally. The server then performs tokenization of prompt sentences, computes embeddings, and executes attention and feed-forward layers using optimized numerical libraries. The server may quantize model weights to reduce memory usage and increase throughput, thereby enabling lower latency in producing the analysis result. By optimizing these low-level operations, the server achieves faster processing speed and better utilization of hardware resources, which is a technical improvement to the computer system itself.

In a further embodiment, the server can support multiple generative AI models with different architectures or sizes. The server may first select a smaller model for low-importance messages and a larger, more accurate model for candidate high-importance messages, based on preliminary heuristics or historical behavior features. This model selection mechanism reduces unnecessary use of computation-intensive models, thereby saving processing time and energy while maintaining high accuracy for critical messages.

The invention is not limited to any specific generative AI provider or communication protocol. The server may use different standardized application programming interfaces, as long as the server generates a prompt sentence that defines an explicit structured output and the server parses the result using deterministic rules. The terminal may execute different operating systems and user interface frameworks, as long as the terminal can receive and display notification messages and can trigger access to the full electronic communication message. The data structures, numerical scoring functions, and learning models can be varied without departing from the spirit of the invention, as long as the core concept of using a generative AI model with a structured prompt sentence to transform unstructured message data into prioritized, structured notification information is maintained.

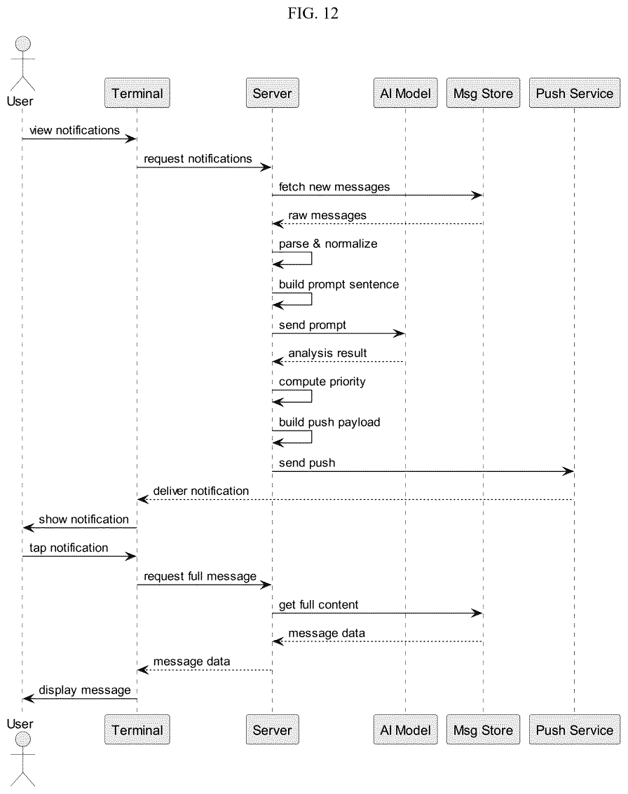

The following describes the processing flow using FIG. 12.

### Step 1:

Server connects to a message storage unit and acquires raw electronic communication messages.

Input: connection parameters (server address, protocol type, authentication credentials) and a retrieval condition (for example, unread messages in a specified mailbox).

Output: a set of raw message objects, each containing header data and body data.

Server uses a mail access library to open a network session to the message storage unit via IMAP, POP, or another messaging protocol. Server authenticates with the provided credentials and issues a query to retrieve messages that satisfy the retrieval condition. Server downloads message headers and bodies in a serialized format (for example, RFC 822) and stores the raw data in memory or temporary storage.

### Step 2:

Server parses the raw message data and generates structured information.

Input: the set of raw message objects obtained in Step 1.

Output: a set of structured message records, each including sender information, subject information, body text information, transmission time information, and a message identifier. Server applies an email parsing library to each raw message object to extract header fields such as “From”, “Subject”, and “Date”, as well as the body part. Server normalizes character encodings to a unified encoding, strips control characters, and removes redundant whitespace.

If the body is formatted in HTML or another markup language, Server uses an HTML-to-text converter to extract plain text. Server then creates an internal record structure, populates sender, subject, body text, and transmission time fields, and assigns a unique message identifier. Server writes these structured records into a database table or other structured data store.

### Step 3:

Server prepares normalized text for analysis and filters messages for AI processing.

Input: the set of structured message records from Step 2 and system configuration parameters (for example, minimum length, target folders, or allowed languages).

Output: a subset of structured message records marked as analysis targets and associated normalized text content.

Server evaluates each structured record against configuration rules, excluding messages that do not meet certain criteria (such as automated notifications already tagged as low priority). Server performs additional text preprocessing, such as lowercasing, removal of signatures or footers based on pattern rules, and segmentation into paragraphs. Server stores the normalized text alongside each record, and flags messages that require AI-based analysis.

### Step 4:

Server builds a prompt sentence for the generative AI model for each target message.

Input: each target structured message record and its normalized text from Step 3.

Output: a prompt sentence string associated with each target message.

Server reads sender, subject, body text, and transmission time fields from the structured record. Server constructs a prompt sentence that instructs the generative AI model to determine importance level, response-or-action necessity, deadline, and summary, and to output results in a strict, machine-readable key-value format. Server concatenates a task description, output format specification, and actual message content into a single text. For example, Server generates a prompt sentence such as:

“You are an assistant that classifies and summarizes electronic messages related to transactions. Using the information below, perform the following tasks:
1. Determine the importance level of the message as ‘high’, ‘medium’, or ‘low’.
2. Determine whether the user must perform an action; if an action is required, specify the action type in one word such as ‘payment’, ‘reply’, or ‘document’.
3. Extract any explicit deadline date or time from the message; if there is no explicit deadline, infer a reasonable deadline or output ‘none’.
4. Provide a concise summary of the message in one sentence, no longer than 40 words.

Output the result in the following structured format:
importance: <high|medium|low>
action_required: <none|payment|reply|document|other>
deadline: <YYYY-MM-DD or ‘none’>
summary: <one-sentence summary>

### Sender:

[insert sender]

### Subject:

[insert subject]

### Body:

[insert body text]

### Sent at:

[insert transmission time]”

Server replaces the bracketed placeholders with actual field values and stores the resulting prompt sentence in memory associated with the message identifier.

### Step 5:

Server sends the prompt sentence to the generative AI model and obtains an analysis result.

Input: the prompt sentence for each target message and AI service parameters (for example, model name, maximum tokens, temperature).

Output: a raw AI output text for each prompt sentence.

Server opens an HTTPS connection to an AI inference endpoint using a standardized application programming interface. Server transmits the prompt sentence as part of a request, specifying the generative AI model to be used and configuration parameters controlling output length and randomness. The generative AI model, which internally implements a transformer-based neural network, processes the prompt by encoding tokens, computing self-attention over the sequence, and generating an output sequence token by token. Server waits for the response and receives a block of text that should follow the specified key-value format. Server logs the request and response for monitoring and later analysis.

### Step 6:

Server parses the AI output and converts it into structured analysis data.

Input: the raw AI output text from Step 5.

Output: a structured analysis record containing importance information, response-or-action necessity information, deadline information, summary information, and status flags.

Server splits the output text into lines and scans for patterns in the form “importance: . . . ”, “action_required: . . . ”, “deadline: . . . ”, and “summary: . . . ”. Server extracts the value portion after each colon, trims whitespace, and normalizes capitalization. Server validates each field: for example, Server checks that importance is one of “high”, “medium”, or “low”, and sets an error flag if the value is unexpected. Server attempts to parse the deadline string into a standardized date format, and if parsing fails, sets deadline to a default such as “none”. Server stores the parsed values and any error flags in a database table linked to the message identifier.

### Step 7:

Server calculates a priority indicator using the structured analysis data.

Input: the structured analysis record from Step 6, along with system configuration parameters such as importance weights, action weights, and additional feature weights.

Output: a numerical priority indicator for each message.

Server maps importance levels to numeric scores (for example, high=3, medium=2, low=1) and maps action types to numeric scores (for example, none=0, reply=2, document=3, payment=4). Server may also compute additional numerical features, such as a length-based factor derived from body text length or a sender-based factor derived from sender categories.

Server multiplies each score by a corresponding weight parameter and sums the results according to a formula defined in configuration. Server thereby converts qualitative attributes into a numeric priority indicator. Server stores the priority indicator in the database for subsequent adjustment.

### Step 8:

Server adjusts the priority indicator based on deadline information and current time.

Input: the priority indicator from Step 7, deadline information from the structured analysis record, and current time information from a system clock or time service.

Output: a final priority value for each message.

Server computes the time difference between the deadline and the current time when the deadline is available. If the deadline is near, Server applies an urgency function, such as adding a value inversely proportional to remaining time or multiplying the indicator by a factor that increases as the deadline approaches. If the deadline is “none” or in the distant future, Server may apply no adjustment or even reduce priority slightly. Server then clips or normalizes the resulting value into a defined numeric range and records the final priority as a separate field. This adjusted value allows Server to prioritize messages that have both high content-based importance and urgent deadlines.

### Step 9:

Server optionally refines weighting parameters using an individual optimization learning model.

Input: historical operation data (for example, which notifications were opened, which messages led to actions), completed action information, and the current set of priority indicators and final priorities.

Output: updated weighting parameters used in priority computation.

Server aggregates user interaction logs and recorded outcomes for previously processed messages. Server uses this dataset to train or update an individual optimization learning model that predicts user engagement or utility based on message attributes and previous priorities.

Server computes gradients of a defined loss function, such as cross-entropy between predicted engagement and actual engagement, and updates the internal weights of the learning model.

Server then derives new values for importance weights, action weights, and channel-specific parameters from the learned model, and writes these values into the configuration storage. Future executions of Step 7 and Step 8 use these updated weights, resulting in dynamically adapted priorities that better reflect user-specific behavior.

### Step 10:

Server generates notification messages based on final priorities and analysis results.

Input: final priority values from Step 8, structured analysis data from Step 6, and a configuration for notification format and thresholds.

Output: a set of outbound notification payloads ready for transmission to terminals.

Server selects messages whose final priority exceeds a predefined threshold or that belong to the top-ranked subset within a time window. For each selected message, Server constructs a notification payload including a concise title (for example, embedding importance and action type), a short body text (for example, including the summary and deadline), a message identifier, and any additional flags. Server may also include a compact code representing final priority for use by the terminal. Server arranges these attributes into a data structure defined by the notification delivery service and stores the payloads in a queue awaiting transmission.

### Step 11:

Server transmits notification messages to terminals through a notification delivery service.

Input: the queued notification payloads from Step 10 and device identifiers associated with user terminals.

Output: delivery requests sent to the notification delivery service, and confirmation or error responses logged by the server.

Server uses a network client library to send each payload to an external notification delivery service over a secure network connection. Server includes the device identifier that specifies the target terminal. Server handles responses from the delivery service, which may include success codes, temporary errors, or permanent failures. Server updates the status of each notification in its database, marking successfully dispatched notifications and scheduling retries for transient failures. This process ensures reliable delivery of prioritized notification information to terminals.

### Step 12:

Terminal receives notification messages and displays them to the user.

Input: notification payloads delivered by the notification delivery service.

Output: visual notifications displayed on the terminal interface and associated local records for user interaction.

Terminal executes an operating system component that listens for incoming notifications.

Upon receipt, Terminal passes the payload to a local application or system notification handler. Terminal extracts the title, body text, priority code, and message identifier from the payload, and creates a visible notification entry in the notification center or lock screen.

Terminal may apply its own sorting logic based on the priority code, placing higher-priority notifications in more prominent positions. Terminal stores necessary identifiers in local storage so that it can request full message details when the user interacts with the notification.

### Step 13:

User reviews notifications and initiates actions through the terminal.

Input: the visible notifications displayed by the terminal in Step 12.

Output: user actions such as opening a detailed view, dismissing notifications, or triggering external processes.

User observes the notification list on the terminal's display and uses input controls to select certain items. User may tap a notification that indicates high importance and an imminent deadline. Terminal detects this interaction and opens a corresponding screen, either within a mail client application or a custom application, presenting more detailed information or offering options such as “Open message”, “Reply”, or “Start payment”. User chooses one of these options to proceed with transaction-related or communication actions.

### Step 14:

Server records user actions and updates internal status.

Input: user action events reported by the terminal or related applications (for example, message opened, reply sent, transaction completed).

Output: updated message records, interaction logs, and training data for subsequent learning. Server receives event notifications indicating that specific actions have been taken with respect to certain message identifiers. Server updates status fields in the corresponding message records, for example marking them as “viewed” or “completed”. Server also stores these events in a log structure, including timestamps and action types, which will later serve as training data for the individual optimization learning model in Step 9. This feedback process enables the system to refine its prioritization and notification strategy over time based on observed user behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional electronic communication management systems largely rely on static rule-based filters, keyword matching, or manually configured notification settings to determine which messages are important and which messages require a user's response. Such approaches are limited in their ability to accurately capture contextual urgency, nuanced intent, or user-specific priorities, and therefore either overwhelm the user with excessive notifications or suppress communications that should be surfaced promptly. As the volume and complexity of electronic communications increase, these limitations create a substantial cognitive burden on the user, who must manually scan and triage messages across multiple applications and devices.

In addition, existing systems that incorporate machine learning or artificial intelligence often treat the analysis as a separate, loosely coupled component, without a tightly defined interaction protocol that constrains the structure and format of the analysis output. As a result, the downstream processing logic in the server frequently requires ad hoc parsing or manual tuning, which leads to inconsistent priority scoring and unreliable notification behavior. This loose coupling reduces reproducibility and degrades the quality and predictability of system-level behavior.

Furthermore, many systems do not incorporate user behavior feedback—such as actual response actions, timing of responses, or message handling patterns—into a closed-loop optimization of the prioritization logic. Without this feedback, the system cannot adapt to individual user preferences and working styles, and cannot systematically improve the mapping between AI-derived evaluations and the concrete notification and prioritization actions carried out by the server and terminal.

Accordingly, there is a need for an improved computer-implemented system that: (i) systematically leverages a generative AI model via a well-defined prompt sentence and output format to evaluate message importance and response necessity; (ii) normalizes and structures the AI output into machine-usable evaluation information for deterministic priority calculation; (iii) coordinates server-side storage, computation, and notification control in a way that reduces user cognitive load; and (iv) incorporates user behavior history into a user-specific optimization model to iteratively refine prompt generation, priority calculation, and notification criteria, thereby improving the overall functioning of the electronic communication management system as a computer technology.

The specific processing by the specific processing unit 290 of the data processing device 12 in Example 2 is realized by the following means.

The present invention provides a server comprising a processor and a storage device, the processor being configured to acquire electronic communication data from a terminal that receives an electronic communication; store, in the storage device, character information and attribute information included in the electronic communication data; extract linguistic information and event information from the electronic communication data and generate a prompt sentence for causing a generative artificial intelligence model to evaluate an importance and a response necessity of the electronic communication; transmit the prompt sentence to the generative artificial intelligence model via an external information processing interface using a communication protocol and obtain, from the generative artificial intelligence model, an analysis result regarding the importance and the response necessity of the electronic communication; normalize the analysis result to generate evaluation information representing an importance category and a response requirement of the electronic communication and convert the evaluation information into numerical information or categorical information; calculate a priority for each of a plurality of electronic communications based on the evaluation information, assign priority information to each electronic communication, and updateably store the priority information in the storage device; determine, based on the priority information and the evaluation information, whether notification to a user is required, generate display information indicating notification content, and transmit the display information to the terminal so that the terminal visually displays the display information and the electronic communication data; and acquire behavior history of the user regarding response operations or processing operations for the electronic communication and update at least one of a generation condition of the prompt sentence and a calculation condition of the priority based on a relationship between the behavior history and the evaluation information. This enables the server to improve the functioning of the computer system by converting unstructured electronic communications into structured, machine-usable priority and response-necessity representations through a constrained interaction with the generative AI model, to deterministically control notification and display behavior across multiple communications, and to adapt the prioritization and prompt-generation logic to user-specific behavior patterns, thereby reducing user cognitive load and enhancing the technical performance and reliability of electronic communication management.

The term “electronic communication” refers to a digital message or information unit transmitted over a communication network, including but not limited to email messages, chat messages, instant messages, system alerts, and notifications.

The term “electronic communication data” refers to data representing an electronic communication, including character information such as a message body and subject, and attribute information such as sender, recipient, timestamp, and message type.

The term “terminal” refers to an information processing device that receives or displays electronic communications, including but not limited to a mobile device, a desktop computing device, a portable computing device, or a web client.

The term “server” refers to an information processing apparatus that executes one or more programs to acquire electronic communication data from a terminal, process the data, interact with external services, and provide results back to the terminal.

The term “processor” refers to hardware circuitry configured to execute instructions of a program, including but not limited to a central processing unit, a graphics processing unit, or a combination thereof.

The term “storage device” refers to a hardware component or subsystem configured to store data and programs, including but not limited to a semiconductor memory, a magnetic storage medium, an optical storage medium, or a combination thereof.

The term “character information” refers to text data contained in an electronic communication, including a subject line, a message body, and any other textual content.

The term “attribute information” refers to metadata associated with an electronic communication, including sender information, recipient information, timestamps, message identifiers, message category, and communication channel type.

The term “linguistic information” refers to information derived from analysis of character information, including tokens, keywords, parts of speech, phrases, sentence boundaries, and semantic indicators.

The term “event information” refers to information indicating an occurrence or condition described in the electronic communication, including time constraints, deadlines, scheduled events, actions to be taken, and contextual circumstances.

The term “prompt sentence” refers to a text string or text sequence constructed to be input to a generative artificial intelligence model, the text string including instructions and electronic communication content to cause the generative artificial intelligence model to perform evaluation or analysis.

The term “generative artificial intelligence model” refers to a machine-learned model configured to generate output data, such as natural language text, in response to an input sequence, and capable of performing tasks including classification, summarization, and evaluation.

The term “external information processing interface” refers to a logical or physical interface used for data exchange between the server and an external information processing system, including but not limited to an application programming interface accessible via a communication network.

The term “communication protocol” refers to a set of rules and formats governing data exchange between computing entities over a network, including but not limited to a transport protocol, a session protocol, or an application-layer protocol.

The term “analysis result” refers to output data generated by the generative artificial intelligence model in response to a prompt sentence, the output data including information about importance, response necessity, or other characteristics of an electronic communication.

The term “importance” refers to a degree or level representing how significant an electronic communication is relative to other communications, with respect to user attention, business impact, or operational relevance.

The term “response necessity” refers to an extent or requirement indicating whether a user should respond to an electronic communication, and if so, within what time frame or urgency.

The term “evaluation information” refers to structured data derived from the analysis result, representing attributes such as an importance category and a response requirement for an electronic communication.

The term “importance category” refers to a classification value indicating a level of importance of an electronic communication, including but not limited to a high level, a medium level, or a low level.

The term “response requirement” refers to a classification value indicating whether and when a response to an electronic communication is needed, including but not limited to immediate response, response within a predetermined period, or no response.

The term “numerical information” refers to one or more numeric values used to represent evaluation information in a quantitative form, such as scores or ranks.

The term “categorical information” refers to one or more symbolic or discrete values used to represent evaluation information in labeled categories, such as priority labels or response requirement types.

The term “priority” refers to an ordering value computed for an electronic communication based on evaluation information, indicating a relative processing or notification order among a plurality of electronic communications.

The term “priority information” refers to data associated with an electronic communication that indicates its computed priority, including at least one of a numerical priority score, a priority class, or an ordering index.

The term “display information” refers to data indicating content to be presented to a user on a terminal, including textual messages, icons, labels, importance indicators, and suggested actions.

The term “notification content” refers to information contained in a notification to the user, including a summary of an electronic communication, its importance, its response requirement, and any recommended user action.

The term “behavior history” refers to data representing past actions of a user with respect to electronic communications, including response operations, viewing operations, deletion operations, postponement operations, and their associated timestamps.

The term “response operation” refers to an action performed by a user in reply to an electronic communication, including sending a reply, forwarding a message, or confirming receipt.

The term “processing operation” refers to an action performed by a user to manage an electronic communication, including opening, closing, archiving, deleting, marking as completed, or postponing.

The term “generation condition of the prompt sentence” refers to one or more parameters, rules, or templates that govern how the prompt sentence is constructed from electronic communication data and associated information.

The term “calculation condition of the priority” refers to one or more parameters, rules, algorithms, or weighting schemes used to compute the priority from evaluation information and other related data.

The term “user-specific optimization model” refers to a data-driven model that uses behavior history and priority information as training data to learn or infer evaluation criteria tailored to an individual user.

The term “importance evaluation criterion” refers to a rule set, function, or model parameter defining how importance of an electronic communication is assessed for a particular user or user group.

The term “response necessity evaluation criterion” refers to a rule set, function, or model parameter defining how response necessity of an electronic communication is assessed for a particular user or user group.

The term “necessity of notification” refers to a condition indicating whether the system should deliver a notification regarding an electronic communication to a user, based on priority information, evaluation information, and user-specific criteria.

In one embodiment, a server executes a program on a processor to manage electronic communications received by a terminal and to prioritize such communications based on importance and response necessity. The server operates as a network-connected computing device, for example a rack-mounted computer including one or more central processing units (CPUs), one or more graphics processing units (GPUs), a main memory, and a nonvolatile storage device such as a solid-state drive. The server runs an operating system such as a UNIX-based system and uses a runtime environment such as a web application framework.

The server communicates with a generative AI model deployed on a remote computation platform, which may utilize GPU hardware such as a parallel processing device, and exposes an application programming interface.

The terminal operates as a client computing device such as a smartphone, a tablet computer, or a laptop computer. The terminal includes a network interface, a display device, an input device, and a local storage. The terminal runs an operating system such as a mobile operating system or a desktop operating system and executes an application that communicates with the server via a secure network protocol. The terminal receives electronic communications using a communication application such as a mail client or a messaging client.

The server stores electronic communication data in a structured format within a storage device such as a relational database management system. The server defines a table for messages that includes fields for a message identifier, a user identifier, a sender identifier, a subject string, a message body string, a timestamp, a message type code, and a status code. The server additionally defines fields for an importance category, a response requirement, a numerical priority score, and an AI analysis timestamp. This particular data structure enables indexed retrieval, sorted queries by priority, and efficient updates of evaluation-related fields, thereby improving data management and query performance compared to unstructured storage.

The server uses a software library for natural language processing, such as a tokenizer and a part-of-speech tagger, to transform character information of an electronic communication into linguistic information. The server performs tokenization, sentence segmentation, part-of-speech tagging, and named entity recognition on the message body and subject. The server extracts event information, such as dates, times, deadlines, and action verbs, by matching patterns in the tokens and by using rule-based detectors. For example, the server detects phrases like “by 2 PM today” or “within one hour” and classifies them as time constraints associated with a high urgency level. The server encodes these extracted features into an intermediate representation, such as a feature vector or a key-value map, including fields for time urgency, presence of imperative verbs, and domain-specific terms.

The server constructs a prompt sentence for a generative AI model based on the linguistic information and event information. The server uses a template mechanism stored in the storage device, where each template defines a fixed instruction text and insertion points for message content and extracted features. The server selects a template according to the message type and user-specific settings. For example, for an email message, the server generates a prompt sentence in the following format:

“You are an assistant that evaluates the priority of electronic communications for a busy professional. Evaluate the importance (High/Medium/Low) and the response necessity (Immediate/Today/Not necessary) of the following message and provide a one-sentence explanation. Message: ‘[message body text]’.”

For a system alert message, the server may generate a different prompt sentence:

“You are an assistant that evaluates technical system alerts. Determine the importance (High/Medium/Low) and the response requirement (Immediate/Within 24 hours/Not necessary) for the alert message below, and output in the form: ‘Importance: [value]; Response: [value]; Reason: [text]’. Alert: ‘[alert text]’.”

The server inserts the actual message body text into the placeholder and may also insert derived context such as detected deadlines or roles (for example, “The message mentions a deadline at 2 PM today.”). In this way, the server defines both the task and the expected output structure in the prompt sentence, thereby constraining the generative AI model to produce a predictable and parseable response.

The server accesses the generative AI model through an external information processing interface such as a network-based API. The generative AI model is implemented as a deep neural network, for example a transformer-based architecture with multiple self-attention layers, feedforward layers, and normalization layers. The generative AI model is trained on large-scale text corpora using a sequence-to-sequence or autoregressive learning objective that minimizes a cross-entropy loss function between predicted tokens and target tokens. During training, the generative AI model updates its internal weight parameters using a stochastic gradient descent method or a variant such as an adaptive moment estimation algorithm. The generative AI model may utilize data augmentation techniques, such as random masking or token dropout, to improve generalization.

The server configures request parameters for the generative AI model, such as maximum output length, temperature, and output format guidance, so that the model generates concise and structured analysis results rather than free-form text. The server sends the prompt sentence over a secure communication protocol, for example Hypertext Transfer Protocol Secure, and includes authentication information such as an access token.

The generative AI model receives the prompt sentence, tokenizes the text into subword tokens according to a predefined vocabulary, and processes the token sequence through the transformer layers. Within each layer, the model computes attention scores between tokens, aggregates contextual information, and applies nonlinear transformations. The model then outputs a sequence of tokens representing the analysis result. The generative AI model may be further fine-tuned using a dataset of messages labeled with importance and response necessity categories, using a supervised loss function that penalizes mismatches between model predictions and reference labels. This fine-tuning adjusts the internal representations to better capture urgency and importance features specific to electronic communications.

The server receives the output text from the generative AI model and parses the text according to the output format specified in the prompt sentence. For example, if the output is in the form “Importance: High; Response: Immediate; Reason: The message includes an urgent deadline,” the server uses regular expressions to extract the string “High” as an importance category and “Immediate” as a response requirement. The server then maps these textual categories to numerical values, for instance mapping “High” to an importance score of 3, “Medium” to 2, “Low” to 1, “Immediate” to a response requirement score of 3, “Today” to 2, and “Not necessary” to 1.

The server combines the numerical importance score and response requirement score with additional heuristic scores derived from event information. For example, the server increases the combined priority score when the message contains multiple time constraints, contains domain-specific high-risk keywords, or refers to system failures. The server implements this combination by a deterministic formula stored as configuration data, such as a weighted sum or a non-linear function. This calculation yields a priority score that can be compared across messages in a consistent manner.

The server updates the corresponding record in the message table with the calculated priority score, the normalized importance category, the normalized response requirement, and the timestamp of the analysis. By structuring the data in this way, the server can execute database queries that order messages by priority and filter by importance or response requirement without additional computation, improving processing speed and reducing CPU load during retrieval.

The terminal periodically or on demand requests prioritized message lists from the server. The server responds with message records sorted by priority score and filtered according to user settings. The terminal displays the prioritized list in a user interface that highlights messages with higher importance and stricter response requirements, for example by coloring, icons, or grouping. The terminal also displays individual message details including the evaluated importance and response necessity, and may provide dedicated controls such as “Reply now,” “Defer,” or “Ignore.”

The user interacts with the terminal to view messages, reply to messages, defer messages, or mark messages as completed. The terminal sends these user actions back to the server as structured events that include message identifiers, action types, and action timestamps. The server records these events as behavior history in a separate table, with fields for user identifier, message identifier, action type, action time, and optionally action duration. By accumulating this behavior history, the server can derive statistical relationships between the AI-evaluated importance and response necessity and the actual user behavior.

The server uses a user-specific optimization model to leverage the behavior history. The user-specific optimization model is implemented as a machine learning model, such as a logistic regression model, a gradient-boosted decision tree model, or a smaller neural network, and is trained separately for each user or for user segments. The server uses features such as message type, AI-evaluated importance, AI-evaluated response requirement, message length, presence of specific entities, and previous response delay as input to the optimization model. The optimization model outputs adjustments to the priority score or adjustments to the thresholds used for notification decisions.

The server trains the user-specific optimization model by minimizing a loss function that measures the difference between predicted user actions (for example, probability of quick response) and actual user actions observed in the behavior history. The server updates the model parameters using a training procedure executed periodically or incrementally. In one example, the server computes gradients of the loss function with respect to model parameters and updates the parameters using a gradient-based optimizer. The server may incorporate regularization terms into the loss function to prevent overfitting.

The server applies the trained user-specific optimization model during subsequent analyses. When the server receives a new analysis result from the generative AI model, the server feeds the evaluated importance and response necessity, along with message features and recent behavior history, into the optimization model. The optimization model outputs an adjusted priority or an adjusted notification requirement that better matches the user's actual preferences and behavior. The server then updates the generation condition of the prompt sentence or the calculation condition of the priority accordingly. For example, the server may modify the prompt sentence to emphasize certain types of urgency that the optimization model has identified as particularly relevant to the user, or adjust weight coefficients in the priority calculation formula.

By defining the prompt sentence format, the output structure, and the mapping from AI outputs to internal data structures, the server constrains and structures the interaction with the generative AI model. This combination of constrained prompt design, deterministic parsing, and numerical mapping results in a reproducible and machine-usable representation of importance and response necessity. This is technically distinct from simply displaying an AI-generated summary to a user, because the server uses the AI output as an intermediate computational artifact that feeds into a defined algorithm for prioritization and notification control.

The server thereby improves the functioning of the computer system as a whole. The server reduces the amount of data that needs to be examined by the user by filtering and prioritizing messages before they are presented. The server reduces computational overhead during retrieval by precomputing priority scores and storing them in indexed database fields, enabling faster querying and sorting than systems that compute priority on the fly for each retrieval request. The server reduces network traffic and notification overhead by deciding whether to send notifications based on precomputed priority and user-specific thresholds, rather than pushing every incoming message.

The use of the generative AI model in this system is not a mere automation of human judgment. The server uses the generative AI model together with specific data structures, numeric mappings, and optimization models to create a multi-stage processing pipeline that cannot be replicated by simple manual sorting or rule-based filters. The generative AI model evaluates complex linguistic and contextual patterns that would be difficult to encode in static rules, and its outputs are systematically converted into calibrated priority scores that are further refined by the user-specific optimization model. This pipeline improves classification accuracy for importance and response necessity, reduces misclassification errors, and accelerates the processing of large volumes of electronic communications.

In another embodiment, the server employs a different generative AI model architecture, such as a recurrent neural network or a hybrid model combining convolutional layers and attention mechanisms. The server can also use a locally hosted model instead of a remote service, with the model parameters stored in the storage device and executed on a GPU installed in the server. In such a configuration, the server loads model parameters into GPU memory and performs inference operations directly, thereby reducing network latency and improving throughput for high-volume deployments.

In yet another embodiment, the server adjusts the prompt sentence dynamically based on system load conditions. For example, under high load, the server shortens the prompt sentence and restricts the requested output format to essential fields, thereby reducing inference time and bandwidth usage. Under normal load, the server may request additional explanatory text or more fine-grained categories. This dynamic prompt adjustment provides a technical effect of maintaining responsiveness and stability of the system under varying computational loads.

In a further embodiment, the server compresses and caches frequently used parts of the electronic communication data and analysis results. The server stores cached results for repeated or similar messages and reuses previous evaluations when appropriate. The server can use hashing of normalized message text to detect duplicates. This caching reduces the number of calls to the generative AI model, thereby decreasing computational resource usage and improving processing speed.

In still another embodiment, the terminal implements local pre-filtering before sending messages to the server. The terminal may apply a lightweight classifier, such as a small decision tree or a keyword-based filter, to ignore trivial notifications. This reduces network traffic and server processing load. The server remains responsible for detailed evaluation and prioritization of messages that pass the local filter.

The described embodiments demonstrate how the combination of specific data structures, constrained prompt sentences, generative AI model architecture, deterministic parsing and mapping, and user-specific optimization models yields a technical improvement in the operation of computer systems used for managing electronic communications. The server, the terminal, and the generative AI model cooperate through defined protocols and algorithms to provide faster, more accurate, and more efficient prioritization and notification than conventional systems that rely on static rules or unstructured AI outputs.

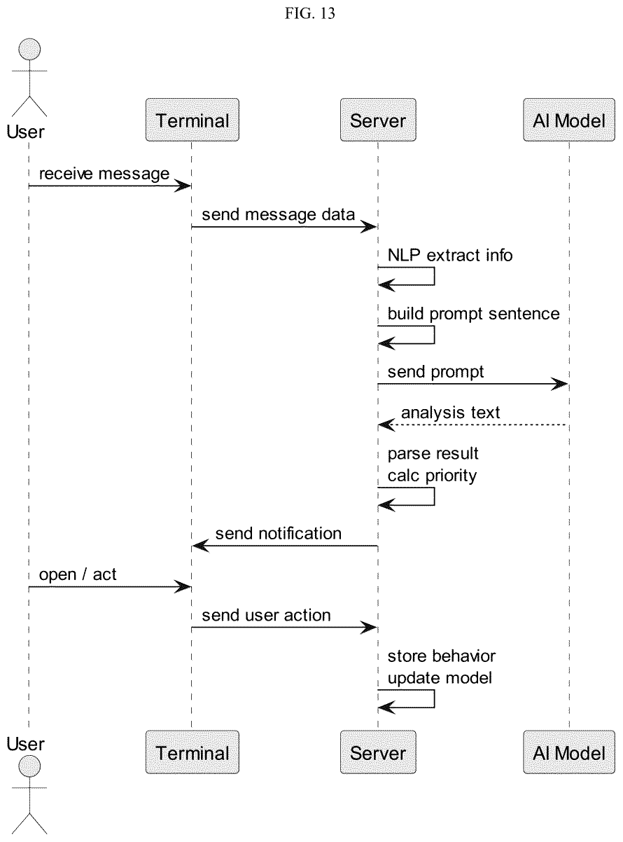

The following describes the processing flow using FIG. 13.

### Step 1:

The terminal receives an electronic communication from a communication service (such as a mail server or messaging server) and generates electronic communication data. The input is protocol-level data including headers and message body. The terminal converts this data into an internal representation that includes a message identifier, sender information, recipient information, subject text, body text, timestamp, and message type. The terminal stores this internal representation in local memory and prepares it for transmission to the server. The output is structured electronic communication data ready to be sent to the server.

### Step 2:

The terminal transmits the structured electronic communication data to the server over a secure network connection. The input is the locally stored electronic communication data including character information and attribute information. The terminal serializes this data into a request payload, for example a JSON object, and sends it via a secure communication protocol such as HTTPS to a predetermined server endpoint. The terminal includes authentication information and user identification. The output is a network request containing the electronic communication data delivered to the server.

### Step 3:

The server receives the network request from the terminal and parses the electronic communication data. The input is the serialized payload containing message identifier, sender, subject, body text, timestamp, and message type. The server validates the payload structure and authentication token, deserializes the JSON into internal data structures in main memory, and logs the reception event. The server then writes the parsed data into a storage device, for example into a relational database table for messages. The output is a persisted message record that can be retrieved by its identifier and associated user.

### Step 4:

The server loads the stored message record and performs linguistic preprocessing on the character information using a natural language processing library. The input is the subject text and body text stored in the message record. The server tokenizes the text into words or subwords, segments sentences, performs part-of-speech tagging, and executes named entity recognition. The server also applies rule-based detectors to identify date and time expressions, imperative phrases, and domain-specific terms. The server encodes these results into a feature representation, such as a list of tokens, a list of entities, and a set of flags indicating urgency indicators. The output is linguistic information and event information associated with the message.

### Step 5:

The server generates a prompt sentence for a generative AI model based on the linguistic information, event information, and raw message text. The input is the feature representation from Step 4 and the original body text. The server selects a template according to the message type and user profile. For example, the server may use the template:

“You are an assistant that evaluates the priority of electronic communications for a busy professional. Evaluate the importance (High/Medium/Low) and the response necessity (Immediate/Today/Not necessary) of the following message and provide a one-sentence explanation. Message: ‘[message body text]’.”

The server inserts the actual message body text into the placeholder and may insert additional context such as “Detected deadline: today 2 PM.” The server concatenates the template components into a single text string. The output is a concrete prompt sentence ready to be sent to the generative AI model.

### Step 6:

The server transmits the prompt sentence to the generative AI model via an external information processing interface and obtains an analysis result. The input is the prompt sentence text and configuration parameters such as maximum output length and temperature.

The server constructs an API request to the generative AI model endpoint, supplies the prompt sentence as input, and specifies that the output should include explicit fields for importance and response requirement, for example:

“Output in the format: ‘Importance: [value]; Response: [value]; Reason: [text]’.”

The generative AI model processes the prompt using its transformer-based architecture, performing attention, matrix multiplications, and nonlinear transformations across layers to generate the output token sequence. The server receives the generated text in a response payload. The output is an analysis result in natural language, typically containing explicit labels such as “Importance: High; Response: Immediate; Reason: The message mentions an urgent deadline.”

### Step 7:

The server parses and normalizes the analysis result into structured evaluation information.

The input is the output text from the generative AI model. The server applies pattern-matching logic, such as regular expressions, to extract the values associated with “Importance:” and “Response:”. The server then maps these text labels to normalized codes, for example mapping “High” to an importance level of 3, “Medium” to 2, “Low” to 1, and mapping “Immediate” to a response requirement level of 3, “Today” to 2, and “Not necessary” to 1. The server stores these numeric and categorical codes in memory as evaluation information.

The output is a structured record containing an importance category, a response requirement, and their corresponding numerical values.

### Step 8:

The server calculates a priority score for the message using the evaluation information and heuristic features. The input is the normalized importance value, the normalized response requirement value, and additional feature values such as counts of time expressions or presence of critical keywords. The server applies a predetermined formula, for example a weighted sum:

priority_score=w1×importance_value+w2×response_value+w3×urgency_feature
where w1, w2, and w3 are weight parameters stored in configuration. The server may also enforce boundary conditions to cap or boost the score depending on message type. The server computes the numerical priority score in main memory and prepares it for storage. The output is a calculated priority score associated with the message.

### Step 9:

The server updates the message record in the storage device with the evaluation information and the priority score. The input is the message identifier, importance category, response requirement, priority score, and analysis timestamp. The server executes an update operation on the message table, setting the corresponding fields for importance, response requirement, priority, and AI analysis time. The server commits the update transaction to ensure persistence. The output is an updated database record that now contains all evaluation-related fields for subsequent retrieval and ordering.

### Step 10:

The server determines whether a notification to the user is required based on the updated evaluation information and user-specific settings. The input is the priority score, importance category, response requirement, and user notification preferences stored in a user settings table. The server compares the priority score against a threshold configured for that user, and evaluates additional conditions such as “notify only if importance is High or Medium” or “suppress notifications during predefined quiet hours.” The server executes this logic using simple comparisons and boolean operations. The output is a notification decision indicating whether to generate a notification and which level of urgency to display.

### Step 11:

The server generates display information representing the notification content and transmits it to the terminal when a notification is required. The input is the notification decision, the message metadata (such as sender and subject), and the evaluation information (importance category and response requirement). The server constructs a concise notification text, for example:

“This message is High importance and requires an immediate response.”

The server then packages this text with the message identifier and priority level into a notification payload. The server sends this payload to the terminal through a push notification service or a persistent connection. The output is a notification payload delivered to the terminal.

### Step 12:

The terminal receives the notification payload from the server and presents the notification to the user. The input is the notification payload containing the message identifier, notification text, and priority level. The terminal invokes its operating system notification interface to display a banner or alert that shows the notification text and, optionally, a visual indicator such as a color or icon based on priority level. The terminal associates the notification with an action that, when selected, opens the corresponding message in the application. The output is a visible notification on the terminal screen allowing the user to access the prioritized message.

### Step 13:

The user interacts with the terminal to view and process the prioritized message. The input is the displayed notification and subsequent user gestures such as tapping the notification or selecting menu options. The user may choose to open the message, reply, defer it, or mark it as done. The user's selection generates an action event within the terminal application. The output is a user action command to be sent to the server, including the message identifier and the chosen action type.

### Step 14:

The terminal transmits the user action command to the server for recording as behavior history. The input is the user action type (for example, reply, defer, ignore), the message identifier, and the action timestamp. The terminal serializes this information into a request payload and sends it to a server endpoint dedicated to recording user behavior. The terminal uses secure communication and includes authentication credentials. The output is a network request containing structured behavior data.

### Step 15:

The server receives the user action command and stores the behavior history in the storage device. The input is the deserialized behavior event data including user identifier, message identifier, action type, and timestamp. The server inserts this data into a behavior history table, optionally including additional derived information such as response delay or number of times the message was opened. The server commits the transaction. The output is a persisted behavior history record associated with the user and the message.

### Step 16:

The server uses the accumulated behavior history and message evaluation data to train or update a user-specific optimization model. The input is a collection of behavior history records, corresponding message evaluation records (importance, response requirement, priority score), and configuration parameters for the learning algorithm. The server aggregates these records into a training dataset, constructs feature vectors (for example, combining importance value, response requirement value, message type, and previous behavior patterns), and computes target labels such as “quick response” or “ignored.” The server then executes a learning algorithm, such as logistic regression or a small neural network, to minimize a loss function measuring the difference between predictions and actual behavior. The output is updated model parameters that represent user-specific evaluation criteria.

### Step 17:

The server adjusts the prompt generation conditions and priority calculation conditions based on the user-specific optimization model. The input is the trained model parameters and current configuration for prompt templates and priority weighting factors. The server analyzes the model to identify which features are most predictive of user behavior, for example that the user tends to respond quickly to messages mentioning specific terms or from specific senders. The server modifies template text to emphasize such features to the generative AI model, and adjusts weights in the priority score formula to increase or decrease the influence of certain evaluation outputs. The output is an updated set of prompt templates and priority calculation parameters tailored to the user.

### Step 18:

The server applies the updated prompt generation and priority calculation in subsequent processing of new messages, thereby closing the optimization loop. The input is the next incoming electronic communication and the updated configuration. The server generates a new prompt sentence that reflects adjusted emphasis, sends it to the generative AI model, receives an analysis result, and computes a priority score based on the revised weights. This updated pipeline produces a priority and notification behavior that better matches the user's actual preferences. The output is improved evaluation and notification decisions, which in turn further refine behavior history and feed back into the optimization process.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern communication environments, users receive large volumes of electronic messages, including transaction-related notifications, invoices, deadlines, and general information. Conventional message processing systems typically rely on static rules, simple keyword filters, or coarse priority flags provided by messaging services. These approaches suffer from several technical problems.

First, conventional systems do not effectively leverage advanced machine learning models, such as generative AI models, to interpret unstructured natural language content and convert it into structured, machine-usable importance and action signals. As a result, important contextual cues such as implicit deadlines, payment obligations, and nuanced action requirements often remain unrecognized at the system level, which limits the precision of automated prioritization and notification.

Second, existing systems generally treat all users in a uniform manner and do not adapt to user-specific behavior patterns. Static rules and global models fail to exploit feedback derived from user interaction history, such as opening, replying, ignoring, or correcting importance, and thus cannot dynamically optimize importance scoring for each individual user. This leads to technically suboptimal notification control in which critical messages may be delayed or overlooked, while low-importance messages may still trigger unnecessary alerts.

Third, configuration of notification behavior in conventional systems often depends on rigid, form-based settings or simple toggles. These mechanisms are poorly suited to expressing complex multi-criteria preferences (for example, “only notify me if there is a near-term payment deadline and the message is from a particular class of counterparties”), and they do not make use of generative AI models to translate high-level, natural-language configuration instructions into formal rule sets. As a result, the system cannot effectively align low-level notification logic with high-level user intent.

Fourth, conventional architectures typically separate text analysis, importance classification, and notification scheduling into loosely coupled modules without an integrated feedback loop.

There is no unified flow in which generative AI outputs, traditional natural language processing, user-specific machine learning, and runtime user feedback are combined to continuously improve message importance evaluation. This architectural limitation reduces the ability of the system to technically improve over time and to reduce processing waste such as unnecessary notifications or redundant user interactions.

Accordingly, there is a need for a computer-implemented system that (i) integrates generative AI model outputs with deterministic natural language processing to produce structured importance and action signals, (ii) applies user-specific machine learning models that are updated with real user operation history, (iii) uses these signals to drive automatic notification timing and job scheduling, and (iv) interprets natural-language configuration instructions via a generative AI model to automatically construct and update notification condition rules. Such a system should technically improve the functioning of the computer-based messaging platform itself by enabling more accurate, personalized, and adaptive control of message prioritization and notification, thereby reducing computational load associated with unnecessary alerts and improving the efficiency with which user attention is allocated by the system.

The specific processing by the specific processing unit 290 of the data processing device 12 in Application Example 2 is realized by the following means.

The present invention provides a server comprising a processor configured to generate a prompt sentence for a generative AI model that embeds target text data representing electronic communication content and instructs the generative AI model to determine an importance of information and a necessity of response; input the prompt sentence to the generative AI model and obtain analysis result data including at least the importance of the information, the necessity of response, deadline information, and summary information; apply a natural language processing technique to the target text data to extract structured attributes including at least date-time information, monetary information, and sender information, and integrate the structured attributes with the analysis result data to compute an importance index and a response urgency index as numerical values; acquire operation history data of a user and cause a machine learning model to learn a relationship among the operation history data, the importance index, and the response urgency index to generate a user-specific importance evaluation model, and calculate a final importance score for each piece of information by using the user-specific importance evaluation model; determine a notification timing based on the deadline information and the final importance score and schedule notification jobs in a task queue; generate a notification message based on the final importance score, the necessity of response, the deadline information, and the summary information, and transmit the notification message as a push notification to a terminal device via a communication network; receive, from the terminal device, operation data representing user interactions including at least opening, replying, ignoring, importance correction, or completion designation, and feed the operation data back into the machine learning model as updated operation history data; and receive a setting instruction sentence expressed in natural language from the user, input a configuration prompt sentence including the setting instruction sentence to the generative AI model to generate machine-readable notification condition rules, and apply the notification condition rules to the determination of the notification timing and to the generation of the notification message. This enables the computer system to technically improve internal message processing by automatically converting unstructured communication content and natural-language user preferences into structured importance scores and notification rules, adaptively updating user-specific models based on real interaction history, and thereby providing more accurate, personalized, and resource-efficient control of message prioritization and notification behavior.

The term “generative AI model” refers to a machine learning model that generates output data, such as text, in response to input data and is capable of performing natural language understanding and generation for tasks including importance evaluation and action recommendation.

The term “prompt sentence” refers to a text string supplied to a generative AI model, the text string including instructions and optionally target text data, and guiding the generative AI model to produce a desired analysis result.

The term “target text data” refers to electronic text content, such as message bodies, subject lines, or other communication content, that is subjected to analysis by the generative AI model and by natural language processing techniques.

The term “analysis result data” refers to structured or semi-structured data output by the generative AI model in response to a prompt sentence, the structured or semi-structured data including at least information concerning importance, necessity of response, deadline, and summary.

The term “importance of information” refers to an evaluation value indicating a relative priority or significance of electronic communication content from the perspective of a user or a system.

The term “necessity of response” refers to an evaluation value indicating whether a user action such as reply, confirmation, payment, or acknowledgement is required or recommended for given electronic communication content.

The term “deadline information” refers to data representing a point in time or a time period by which a specific action related to electronic communication content should be performed.

The term “summary information” refers to condensed text representing key points of electronic communication content in a shorter and more easily understandable form.

The term “natural language processing technique” refers to a computational technique for analyzing and processing human language text, including at least tokenization, part-of-speech tagging, entity extraction, and pattern recognition.

The term “date-time information” refers to information parsed or extracted from text that represents a calendar date, a time of day, or a combination thereof.

The term “monetary information” refers to information parsed or extracted from text that represents an amount of money, including a numeric value and optionally a currency type.

The term “sender information” refers to information indicating an originator of electronic communication content, including identifiers such as an address, a domain, or a name.

The term “importance index” refers to a numerical representation derived from analysis result data and structured attributes that quantifies how important electronic communication content is.

The term “response urgency index” refers to a numerical representation derived from analysis result data and structured attributes that quantifies how urgently a user is expected to respond to electronic communication content.

The term “operation history data” refers to recorded data representing past user interactions with electronic communication content, including actions such as opening, replying, ignoring, marking as important, or marking as completed.

The term “machine learning model” refers to a computational model trained on data to learn relationships among input variables and to perform prediction, classification, or scoring of new data.

The term “user-specific importance evaluation model” refers to a machine learning model that has been trained using operation history data of a particular user and is configured to output an importance score tailored to the behavior pattern of that user.

The term “final importance score” refers to a numerical score representing a result of importance evaluation for electronic communication content, computed by applying the user-specific importance evaluation model to analysis result data and structured attributes.

The term “notification timing” refers to a point in time or a schedule at which a notification about electronic communication content is to be delivered to a terminal device.

The term “notification job” refers to a scheduled task registered in a task queue or scheduler that, when executed, causes a notification message to be transmitted to a terminal device.

The term “notification message” refers to content generated by the processor for presentation to a user, the content including at least information about importance, necessity of response, deadline, or summary for electronic communication content.

The term “terminal device” refers to an electronic apparatus operated by a user, such as a mobile device, a tablet device, or a personal computer, that receives and displays notification messages.

The term “operation data” refers to data representing user actions performed in response to notification messages or displayed communication content, including opening, replying, ignoring, correcting importance, or indicating completion.

The term “setting instruction sentence” refers to a natural-language text input by a user expressing a configuration request or preference regarding notification behavior or importance evaluation.

The term “configuration prompt sentence” refers to a prompt sentence that includes a setting instruction sentence and instructs a generative AI model to convert the setting instruction sentence into machine-readable control rules.

The term “notification condition rules” refers to machine-readable rules specifying conditions and associated actions for controlling whether, when, and how notifications are generated and delivered for electronic communication content.

The term “application programming interface integration model” refers to a programmatic interface arrangement by which the processor exchanges data, including prompt sentences and analysis result data, with an external generative AI model or external information processing apparatus.

The term “electronic communication data” refers to data representing electronic messages exchanged over a network, including email messages, instant messages, and similar digital communication content.

The term “emotion estimation model” refers to a machine learning model configured to estimate an emotional state or sentiment associated with electronic communication content or with a user's reaction, based on textual or other features.

The term “notification control function” refers to a processing function that determines, based on scores, rules, and model outputs, whether to generate a notification, what content to include in the notification, and when to deliver the notification.

The term “information search function” refers to a processing function that retrieves, filters, or ranks information items for presentation to a user, based on query parameters, importance scores, or other criteria.

The term “paid option” refers to a function or service feature of the system that is made available to a user subject to a payment condition or subscription condition.

In one embodiment, a server executes a computer program on one or more processors and memories to implement the claimed system. The server operates in conjunction with at least one terminal and at least one communication network. The server includes a network interface, a persistent storage device such as a relational database, and a computation unit capable of executing machine learning frameworks. The server executes an operating system such as a general-purpose server operating system and application software implemented, for example, in a programming language suitable for network services.

The server stores electronic communication data in a structured data model. The server represents each message as a record including at least a message identifier, a user identifier, header fields, body text, timestamps, and analysis attributes such as importance scores and deadline values. The server stores these records in a data store, for example, in tables of a relational database management system. The server additionally stores operation history data, notification condition rules, and model parameters in associated data structures.

The server uses software modules for natural language processing. The server can employ language-processing libraries such as tokenizers, part-of-speech taggers, and named entity recognizers to transform raw message text into token sequences and feature vectors. The server uses such modules to extract features including date-time expressions, currency amounts, sender domains, and lexical indicators of obligations or requests. The server encodes these features into numeric vectors that serve as inputs to machine learning models.

The server uses a generative AI model as a programmable component for semantic analysis.

The server may employ a transformer-based neural network model hosted by an external service or by an internal inference engine. The generative AI model comprises multiple layers of self-attention and feedforward neural network layers and has been pre-trained on large text corpora. The server does not rely on the generative AI model as an opaque component; instead, the server constrains the generative AI model by supplying a prompt sentence that encodes specific instructions and output formats.

The server generates a prompt sentence by concatenating fixed instruction segments, schema descriptions, and the target text data. The server constructs, for example, the following prompt sentence:

“You are an assistant that analyzes electronic messages.

Analyze the following message and output a JSON-like structure with these fields:
importance_level (high, medium, low),
action_required (yes or no),
deadline (explicit date or ‘none’),
amount (numeric value or ‘none’),
summary (one-sentence summary in English),
category (invoice, receipt, deadline_notice, general, or other).

Message body: “<message body text>”.”

The server then transmits this prompt sentence as a request payload to the generative AI model. The server configures the request with parameters such as temperature and maximum output length to encourage deterministic, schema-conformant output. The server receives text output from the generative AI model and applies a parser to extract the structured fields. The server validates the parsed values against allowed sets, for example checking that importance_level is one of predetermined values, and converts date strings to internal timestamp representations by using a date parser component.

The server performs additional natural language processing independently of the generative AI model. The server applies deterministic pattern matching and named entity recognition to the message body in order to detect date-time expressions and amounts that may not have been explicitly returned by the generative AI model, and to cross-validate the AI output. The server combines the AI-derived attributes with deterministically extracted attributes to form a feature vector. This combination reduces misclassification errors and increases robustness to unusual phrasing, because errors in one subsystem can be compensated by information from the other subsystem.

The server maintains a user-specific importance evaluation model for each user or group of users. The server implements this model as a supervised learning classifier or regressor, for example a feedforward neural network or a gradient boosting model trained with machine learning libraries. The server takes as input a feature vector comprising at least AI-derived categories (such as importance_level and action_required), deterministic features (such as presence of explicit deadlines, amount magnitude, and sender type), and behavioral features (such as historical open latency for this sender, frequency of replies, and prior manual importance corrections by the user). The server trains the user-specific importance evaluation model by minimizing a loss function, for example cross-entropy loss for classification of whether a message is urgent or not. The server updates the model weights by using gradient-based optimization such as stochastic gradient descent or an adaptive method.

The server uses this user-specific importance evaluation model to compute a final importance score. The final importance score is a quantitative measure, for example a value in a fixed range, that estimates the likelihood that the user will need to act promptly on the message. By combining semantic judgments from the generative AI model with statistical patterns learned from the user's history, the server improves prediction accuracy beyond what either subsystem can achieve alone. This reduction in prediction error directly improves system-level behavior, because the server can more precisely schedule notifications and filter out low-value notifications, thereby reducing network traffic and processor usage associated with unnecessary alerts.

The server stores notification condition rules generated from natural-language configuration instructions. The server accepts, from a terminal, a setting instruction sentence such as:

“Only notify me about important emails.”

“Do not notify me about newsletters, but always alert me for payment deadlines.”

The server generates a configuration prompt sentence that describes the internal fields and rule structure and includes the setting instruction sentence. The server, for example, constructs the following configuration prompt sentence:

“The user wants to configure notification rules.

Convert the following instruction into machine-readable rules on fields: importance_score (0-100), category (invoice, deadline_notice, general, newsletter), sender_type (trusted, unknown).

Output only a rule description in plain text specifying threshold values and logical conditions.

User instruction: “Only notify me about important emails.””

The server sends the configuration prompt sentence to the generative AI model, receives a textual rule description, parses the description into a formal rule object, and stores it in the database. The rule object may specify, for example, that notifications are only sent when importance_score exceeds a threshold or when category indicates a certain type. Because the generative AI model transforms a high-level instruction into a structured rule set, the server can avoid predefining a large number of fixed toggle options, and the server can support nuanced user intentions without complex manual configuration interfaces.

The server executes an emotion estimation model in some embodiments. The server implements this model as a neural network, for example a transformer or bidirectional recurrent network, trained on labeled data consisting of messages and associated sentiment labels. The server uses token embeddings and positional encodings and trains the model by minimizing a loss function over sentiment classes. The server feeds cleaned message text, as well as optional metadata such as sender type, into the emotion estimation model. The server obtains a probability distribution over emotion classes and derives an emotion score. The server combines the emotion score with the importance score when determining notification behavior. When the server detects a message with moderate importance but strong negative sentiment, the server may elevate its priority so that the user is informed promptly.

The server controls notification job scheduling using a task queue mechanism. The server calculates, for each message, a recommended notification time based on the deadline information and the final importance score. The server may schedule multiple notifications at different offsets relative to a deadline. The server enqueues notification jobs into a job queue stored, for example, in memory or in a persistence layer. The server periodically or event-driven processes the queue, generates notification payloads, and sends them through a push notification service.

The server constructs each notification payload as a compact representation. The server includes only essential elements, such as the summary, the due date, and an indicator of the importance, and excludes unnecessary metadata. By compressing the payload at the server, the system reduces bandwidth consumption and power usage on the terminal side, which constitutes a technical improvement in communication efficiency. The server also includes a link or identifier in the payload so that the terminal can request full details if the user chooses to open the message.

The terminal operates as a client device that receives notifications and displays them. The terminal may be a mobile device, a tablet, or a general-purpose computing device executing a client application. The terminal receives push notifications via a platform-specific notification service. The terminal renders a user interface that lists messages along with importance indicators, deadlines, and summarized content provided by the server. The terminal may use visual elements such as color coding, icons, and ordering to distinguish urgent messages from less important ones. The terminal transmits user actions, such as opening a message, responding, dismissing a notification, or manually correcting an importance label, back to the server via a communication protocol.

The user interacts with the terminal by reviewing notifications, opening messages, and performing actions such as replying to a message, initiating a payment through a payment application, or marking a task as completed. The user may also interact with a configuration interface that accepts natural-language instructions. The user's behavior, including the timing and type of interactions, becomes part of the operation history data. The server uses this operation history data as training data and as feedback to adjust its models. Because the models learn from patterns across many interactions, the system operates in a manner that is not limited to a simple, static rule set that a human might define manually.

The server improves computer technology by organizing the data and computations in a way that optimizes resource usage and prediction accuracy. The server reduces the number of calls to the generative AI model by caching results for similar messages or by applying heuristics to bypass the AI analysis for messages that are clearly low-importance based on simple patterns. The server applies vectorization and batching when sending prompt sentences, which reduces overhead on network and compute resources. The server maintains compact numeric representations of features and performs matrix operations that are efficient on modern processors. Through these measures, the server improves processing throughput and reduces latency when handling large volumes of messages.

The server enhances data management by storing derived importance scores, deadlines, and rules in indexed fields. The server can quickly search for messages that meet certain importance criteria or deadlines, which enhances the efficiency of queries and internal operations compared to systems that must parse and re-interpret raw text on every query. This structured storage enables the server to execute scheduling algorithms and to monitor system behavior in real time.

The server also implements non-conventional processing flows that differ from manual human evaluation. The server does not merely automate reading and categorizing messages in a human-like sequence; instead, the server integrates probabilistic model outputs, deterministic rule checks, and user feedback loops into a pipeline that uses multi-level features and hidden representations. For example, the server may reduce more than one thousand sparse text features down to a dense vector representation using neural network layers and then apply a user-specific classifier that operates on this dense representation. This process cannot be practically replicated by human operators and yields consistent numerical outputs that are directly usable by scheduling and control mechanisms.

In alternative embodiments, the server may host the generative AI model locally rather than using an external service. In such embodiments, the server loads model parameters into memory and executes forward passes directly on attached graphics processing units. The server maintains the same prompt sentence structure but can adjust model architectures, such as number of layers or attention heads, to match hardware capabilities. The server can also adjust training routines to fine-tune the model on domain-specific datasets, further improving analysis precision for particular categories of messages.

In another embodiment, the server may use different types of machine learning models for user-specific importance evaluation, such as a recurrent network that captures temporal dependence in user behavior, or an ensemble of decision trees that provides interpretable rules. The server may select a model type per user based on the amount of available data and computational constraints. For users with limited history, the server may rely more heavily on the generative AI model and generic behavioral priors, while for users with extensive history the server may exploit rich behavioral models.

In yet another embodiment, the server may incorporate reinforcement learning mechanisms.

The server may treat notification decisions as actions in an environment and measure outcomes such as whether the user responded to the notification in a timely manner. The server may adjust parameters of the importance evaluation and notification scheduling algorithms to maximize a reward function that balances missed critical messages against unnecessary interruptions. Such adaptation further refines performance and confirms that the system is technically oriented toward optimizing computational policy, not merely mirroring a fixed set of human instructions.

In all embodiments, the server remains configured to generate prompt sentences, process responses from a generative AI model, apply additional natural language processing, maintain and update user-specific importance evaluation models, generate and schedule notifications based on structured scores and rules, and receive feedback via terminal devices. This integrated architecture provides concrete and measurable improvements in processing speed, accuracy of importance classification, communication efficiency, and computational resource utilization, thereby improving the functioning of the computer-based messaging system itself in a manner that is grounded in specific data structures, algorithms, and model configurations.

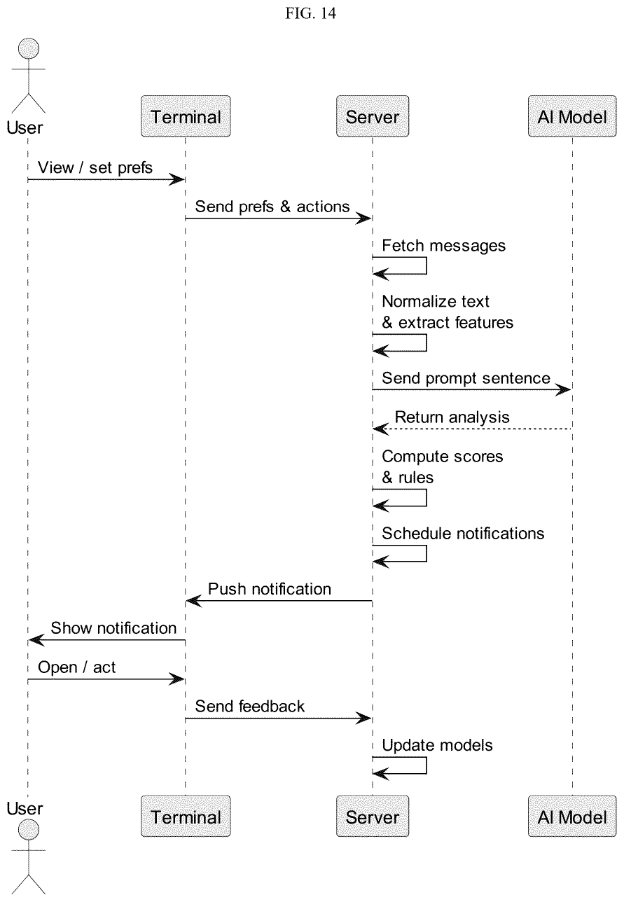

The following describes the processing flow using FIG. 14.

### Step 1:

Server acquires electronic communication data from one or more message sources.

Server uses a communication protocol or a service API to connect to a message source and retrieve raw message data.

Input: message source connection information and user account information.

Server sends an access request (for example, using a mail access protocol or web API), receives raw message headers and bodies, and writes them into a storage structure as records including identifiers, sender information, subject strings, and raw body text.

Output: stored raw message records in a database or equivalent data store.

### Step 2:

Server normalizes raw message text into structured internal text fields.

Server parses the raw message using a message parsing library, strips markup, and converts different encodings into a unified encoding.

Input: raw message records containing headers and body segments.

Server identifies the main text part, removes markup tags, decodes character sets, and removes repeated quoted segments and signatures by applying heuristic rules and regular expressions. Server stores cleaned text as a normalized text field associated with each message record.

Output: message records updated with normalized text data.

### Step 3:

Server extracts deterministic linguistic and semantic features from the normalized text.

Server uses natural language processing modules such as tokenizers, part-of-speech taggers, and entity recognizers to compute feature values.

Input: normalized text data for each message.

Server tokenizes the text into sentences and words, tags parts of speech, recognizes named entities such as dates, times, organizations, and monetary amounts, and applies pattern recognition to detect phrases indicating obligations or deadlines. Server encodes these results into structured attributes (for example, extracted dates, amounts, sender category) and writes them into the message records.

Output: message records enriched with deterministic feature attributes.

### Step 4:

Server constructs a prompt sentence for a generative AI model by embedding the target text and describing an expected output schema.

Server concatenates instruction segments with the normalized text and any selected metadata.

Input: normalized text data, extracted feature attributes, and predefined instruction templates.

Server generates a formatted text such as:

“You are an assistant that analyzes electronic messages.

Analyze the following message and output a structure with fields: importance_level (high, medium, low), action_required (yes or no), deadline (date or ‘none’), amount (numeric or ‘none’), summary (one-sentence summary), category (invoice, deadline_notice, general, or other).

Message body: “<normalized text>”.”

Server logs this prompt sentence and associates it with the corresponding message identifier.

Output: prompt sentences prepared for each message.

### Step 5:

Server sends the prompt sentence to a generative AI model and obtains analysis result data.

Server uses a network client library to call a generative AI inference endpoint.

Input: prompt sentence and model call parameters such as model identifier, maximum output length, and randomness settings.

Server constructs a request payload that includes the prompt sentence, transmits it to the generative AI model via a secure network connection, waits for completion, and receives a textual response. The response contains AI-generated analysis results, typically formatted according to the requested schema.

Output: raw AI output text associated with each message.

### Step 6:

Server parses the AI output into structured analysis result data.

Server applies parsing rules to convert the textual AI response into typed values.

Input: raw AI output text for each message.

Server locates the structured part of the response, extracts field values such as “importance_level=high”, “action_required=yes”, “deadline=2026 Feb. 2”, “amount=25000”, “summary=‘Credit card payment due in three days’”, and converts them into internal types. Server validates that categorical fields belong to allowed sets and converts date strings to timestamp values and numeric strings to integer or floating-point values. Server stores these fields as AI-derived attributes attached to the message records.

Output: message records updated with AI-derived structured attributes.

### Step 7:

Server integrates deterministic features with AI-derived attributes to compute base importance and urgency indices.

Server uses a feature combination algorithm to aggregate multiple signals into numeric indices.

Input: deterministic feature attributes (for example, explicit deadlines, amount magnitude, sender category) and AI-derived attributes (for example, importance_level, action_required, AI-detected deadline).

Server maps categorical importance levels to numeric values, applies weighting coefficients to different features, and computes a base importance index and a base response urgency index using a predefined formula or a simple regression model. Server writes these indices into the message records.

Output: message records containing base importance index and base response urgency index.

### Step 8:

Server evaluates emotional impact using an emotion estimation model.

Server executes an emotion classification model on the normalized text to determine likely sentiment.

Input: normalized text data and optional metadata such as sender type.

Server converts the text into token indices, feeds them through an emotion estimation neural network, obtains a score distribution over emotion categories, and computes an emotion score indicating the intensity and polarity of sentiment. Server adds the emotion category and emotion score to the message record.

Output: message records augmented with emotion category and emotion score.

### Step 9:

Server calculates a final importance score with a user-specific importance evaluation model.

Server uses a machine learning model trained on past behavior of the respective user.

Input: base importance index, base response urgency index, emotion score, AI-derived attributes, deterministic features, and user operation history features for the same sender or similar messages.

Server constructs a feature vector, normalizes each component as required by the model, and performs a forward pass through the user-specific model (for example, a neural network or an ensemble classifier). Server obtains a probability or score that reflects how likely the user is to treat the message as important and urgent. Server combines this model output with the base indices to produce a final importance score, writes the score into the message record, and assigns a priority class.

Output: message records containing final importance score and priority class.

### Step 10:

Server generates or updates notification condition rules based on natural-language configuration instructions.

Server processes user-entered sentences describing notification preferences.

Input: setting instruction sentences received from the terminal and stored rule templates describing available fields and actions.

Server constructs a configuration prompt sentence that describes internal fields and asks the generative AI model to convert the user instruction into rule conditions. Server sends this configuration prompt sentence to the generative AI model, receives a textual rule description, parses it into a rule representation (for example, threshold values and category conditions), validates it, and stores it as notification condition rules associated with the user.

Output: stored notification condition rules that can be applied to importance scores and categories.

### Step 11:

Server determines notification timing and schedules notification jobs.

Server uses the final importance score, deadline information, and notification condition rules to decide whether and when to notify.

Input: message records containing final importance score, deadline timestamps, emotion information, and stored notification condition rules.

Server evaluates each message against the rules, confirms whether notifications are allowed or required, computes recommended notification times based on deadlines and urgency (for example, at a fixed interval before deadline), and creates one or more notification job entries.

Each job entry includes message identifier, user identifier, scheduled time, and basic payload content. Server inserts these jobs into a job queue or scheduling subsystem.

Output: scheduled notification jobs stored in a queue or scheduler.

### Step 12:

Server generates notification messages and transmits them to the terminal as push notifications.

Server processes due notification jobs and prepares compact payloads.

Input: notification jobs whose scheduled time has arrived and corresponding message records (final importance score, summary, deadline, and category).

Server formats notification texts such as “High priority: Payment of 25,000 is due in 3 days.

Action required: complete payment.”, attaches identifiers for deep linking, minimizes payload size by omitting nonessential data, and sends the notifications using a push notification service. Server logs transmission results and any errors for monitoring.

Output: push notification payloads delivered to terminals and transmission logs stored on the server.

### Step 13:

Terminal receives notification messages and presents them to the user.

Terminal processes push notifications according to platform-specific mechanisms.

Input: push notification payloads received from the server via the notification service.

Terminal parses the payload, displays a visual alert such as a banner, lock-screen notification, or list item, and renders the summary, deadline, and importance indication. Terminal may apply UI elements such as color coding or icons based on priority class.

Output: on-screen notification elements and updated local state indicating new notifications.

### Step 14:

User interacts with notifications and message content via the terminal.

User decides whether and how to respond based on the information presented.

Input: displayed notification elements and message list displayed by the terminal application.

User taps a notification to open the corresponding message detail view, replies to the message, initiates a transaction, dismisses the notification, marks the message as completed, or adjusts importance labels. User may also open a settings interface and enter natural-language configuration instructions such as “Only notify me about important emails.” or “Do not notify me about newsletters, but always alert me for payment deadlines.”

Output: user actions captured by the terminal as operation events and configuration instructions.

### Step 15:

Terminal transmits user operation data and configuration instructions back to the server.

Terminal sends structured reports of user behavior for use as feedback.

Input: operation events (for example, open, reply, ignore, mark important, mark not important, complete) and configuration instruction text entered by the user.

Terminal packages these events into messages containing user identifier, message identifier, timestamps, action types, and any manual importance adjustments or configuration sentences.

Terminal sends this data to the server via an application protocol.

Output: feedback data and configuration instruction data received by the server.

### Step 16:

Server updates operation history data and retrains or fine-tunes user-specific models.

Server incorporates new feedback into training datasets and refines model parameters.

Input: feedback data representing user operations and outcomes, along with existing operation history and model parameters.

Server appends new operation events to operation history tables, prepares training samples that pair features with observed importance outcomes (for example, whether an urgent message was opened quickly), and re-computes model parameters by executing a training routine. Server minimizes a loss function (for example, cross-entropy or mean squared error) using gradient-based optimization, updates weights of the user-specific model, and validates performance on a hold-out set. If performance improves, server replaces the previous model with the updated model for future importance predictions.

Output: updated user-specific importance evaluation models and extended operation history data used in subsequent processing.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

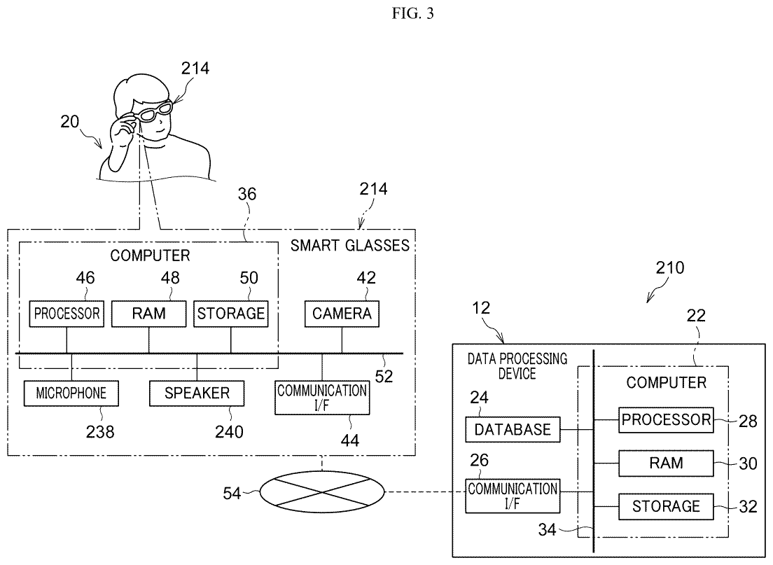

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

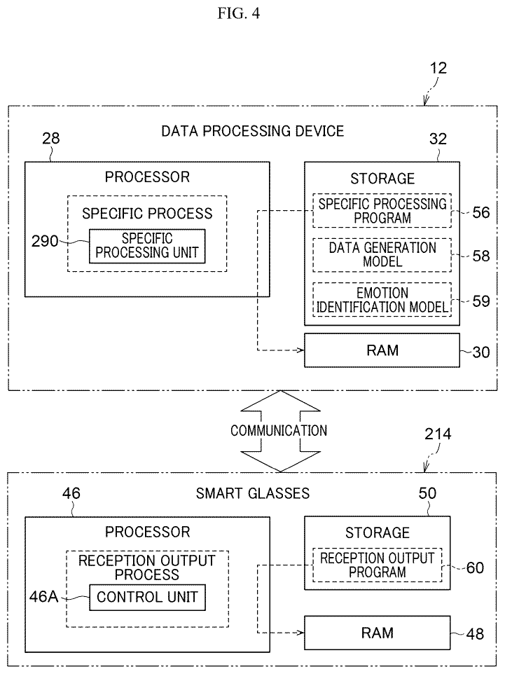

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

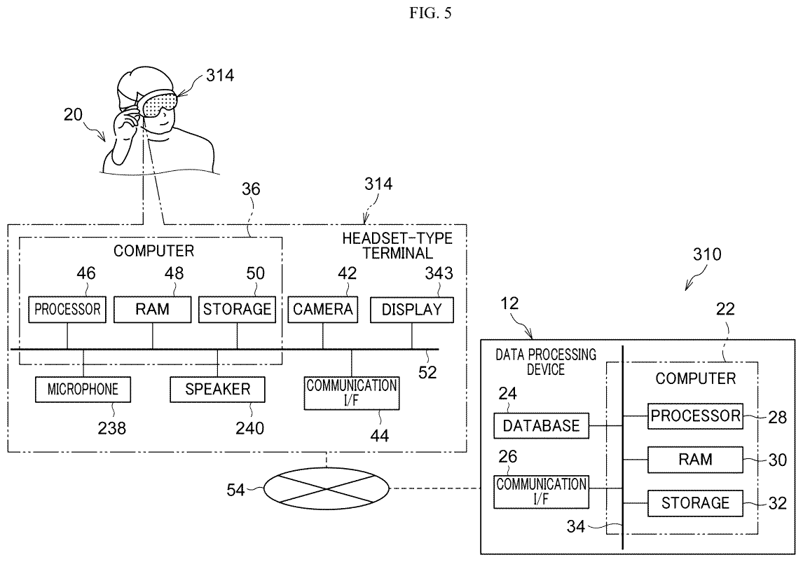

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

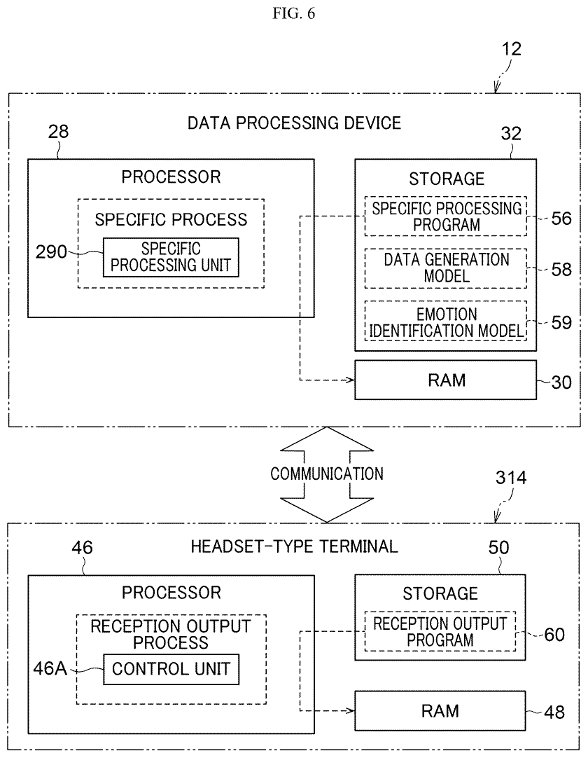

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

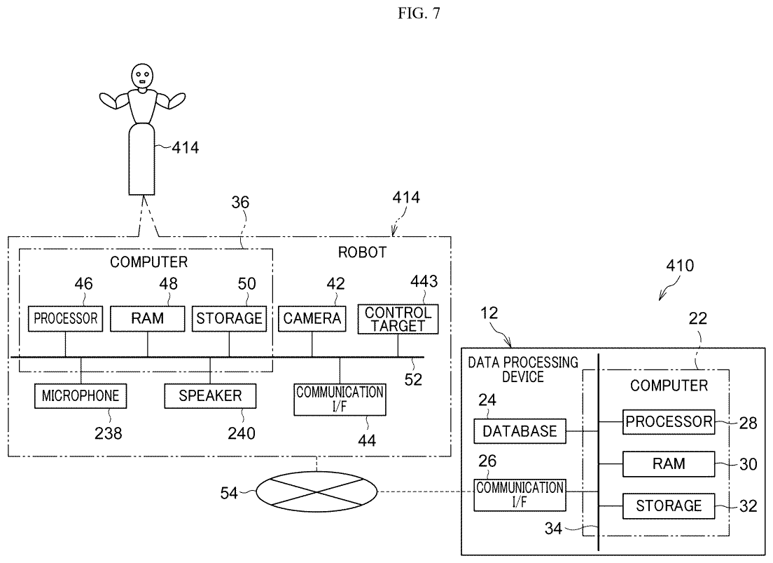

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

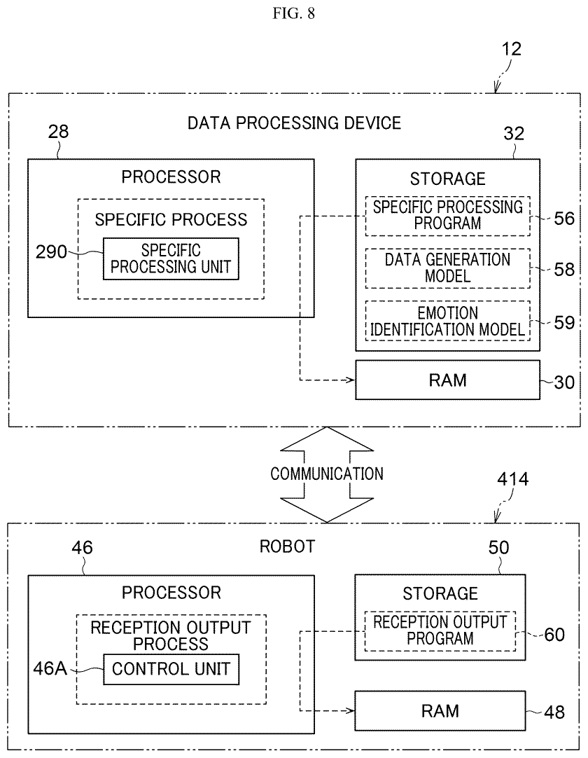

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

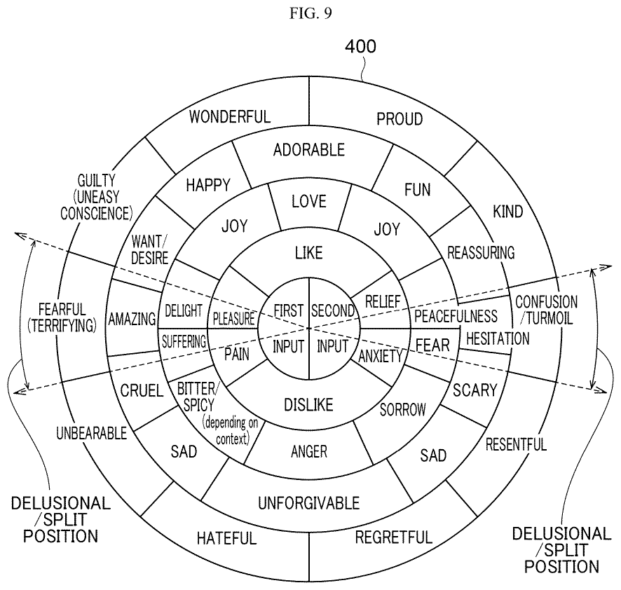

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

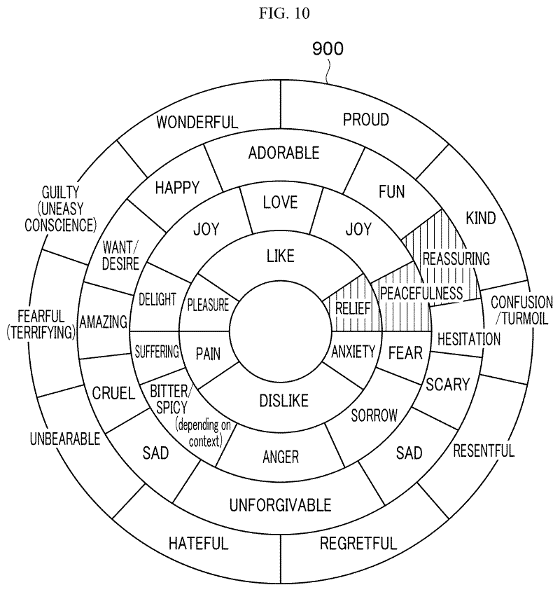

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device, a communication interface, and a terminal device,
wherein the processor is configured to
store electronic message data acquired from a communication device as analysis target data in the storage device,
extract sender information, subject information, body information, and time information from the analysis target data, normalize the extracted information as structured data, and store the structured data in the storage device,
transmit at least a part of the structured data to an external information processing service having a natural language processing function, and acquire, from the external information processing service, analysis result data including topic information, sentiment information, keyword information, and date-time expression information,
calculate, based on the analysis result data and the structured data, feature values including source attributes, linguistic expressions, sentiment indices, length indices, and classification indices, and determine an importance score and a necessity of response or action for each piece of the electronic message data,
accumulate behavior history data including at least viewing operations, response operations, storage operations, and deletion operations of a user with respect to the electronic message data, generate or update a user-specific machine learning model based on the behavior history data, and correct the importance score and the necessity of response or action for each user by using the user-specific machine learning model,
generate a prompt sentence for a generative artificial intelligence model so as to automatically extract or supplement summary information and deadline information in natural language from the analysis result data and the feature values, the prompt sentence including at least the structured data and the analysis result data,
input the prompt sentence and the electronic message data into the generative artificial intelligence model, and acquire, from the generative artificial intelligence model, response data including at least summary information, action item information, and deadline information,
register, in a search platform, search index data including the electronic message data, the corrected importance score, the corrected necessity of response or action, the deadline information, and the summary information,
provide, based on user attribute information, a basic search function using the search index data to a non-paying user and an extended search function including at least an importance condition, a deadline condition, and an action-necessity condition to a paying user,
generate, in response to an acquisition request from the terminal device, list information including the electronic message data and, for each piece of the electronic message data, the corrected importance score, the corrected necessity of response or action, the deadline information, and the summary information, and transmit the list information to the terminal device via the communication interface,
and
receive, from the terminal device, feedback information including at least viewing, response, flagging, or removal relating to the electronic message data, store the feedback information as part of the behavior history data in the storage device, and reuse the behavior history data for training or updating the user-specific machine learning model.

### Supplementary 2

The system according to supplementary 1,
wherein the processor is configured to
provide, via the communication interface, an application programming interface for transmitting request information including the electronic message data, the analysis result data, and the prompt sentence, and for receiving response information including the summary information, the action item information, and the deadline information between the generative artificial intelligence model and an external information processing apparatus, and
allow the external information processing apparatus to acquire, through the application programming interface, at least the importance score, the necessity of response or action, the deadline information, and the summary information determined by the processor.

### Supplementary 3

The system according to supplementary 1,
wherein the processor is configured to
select configuration elements of a user-specific optimization model, the configuration elements including at least an importance determination model, an action-necessity determination model, and a search result ranking model, in accordance with at least an amount of the behavior history data and a user attribute,
rank search results for queries to the search index data by using the user-specific optimization model,
and control provision conditions or fee conditions of an information search service for the paying user based on the ranked search results.

### Application Example 1

### Supplementary 1

A system comprising a processor and a communication interface,
wherein the processor is configured to
acquire electronic communication message data via the communication interface from a message storage unit, and extract structured information including sender information, subject information, body text information, and transmission time information from the electronic communication message data,
generate, on the basis of the structured information, a prompt sentence that instructs a generative AI model to determine an importance level of the electronic communication message, a necessity of a response or another action with respect to the electronic communication message, a deadline related to the electronic communication message, and a summary of the electronic communication message, and input the prompt sentence to the generative AI model via an application programming interface,
obtain an analysis result output from the generative AI model in response to the prompt sentence, mechanically interpret the analysis result as structured data including importance information, response-or-action necessity information, deadline information, and summary information, and convert at least the importance information and the response-or-action necessity information into numerical indicators to calculate a priority indicator for the electronic communication message,
correct the priority indicator on the basis of the deadline information and current time information to determine a final priority for the electronic communication message,
generate, on the basis of the final priority, the summary information, the deadline information, and the response-or-action necessity information, a notification message to be transmitted to a user terminal via a notification delivery service over a network,
and the processor is further configured to
cause the notification message to be transmitted through the notification delivery service to the user terminal so that the user terminal displays the notification message as visual information that enables a user to activate display of the corresponding electronic communication message or execute a related process based on the notification message.

### Supplementary 2

The system according to supplementary 1,
wherein the processor is configured to
transmit the prompt sentence and receive the analysis result to and from the generative AI model via a standardized application programming interface, and explicitly specify, in the prompt sentence, an output format as a machine-readable structured format so as to improve mechanical interpretation accuracy of the analysis result.

### Supplementary 3

The system according to supplementary 1,
wherein the processor is configured to
hold an individual optimization learning model that learns weighting parameters regarding the importance level and the necessity of the response or the other action, based on operation history information and completed action information of the user, and dynamically correct the priority indicator and the final priority of the electronic communication message by using the weighting parameters updated by the individual optimization learning model.

### Example 2

### Supplementary 1

A system comprising a processor,
wherein the processor is configured to
acquire electronic communication data from a terminal that receives an electronic communication; and
store, in a storage device, character information and attribute information included in the electronic communication data; and
extract linguistic information and event information from the electronic communication data and generate a prompt sentence for causing a generative artificial intelligence model to evaluate an importance and a response necessity of the electronic communication; and
transmit the prompt sentence to the generative artificial intelligence model via an external information processing interface and obtain, from the generative artificial intelligence model, an analysis result regarding the importance and the response necessity of the electronic communication; and
normalize the analysis result to generate evaluation information representing an importance category and a response requirement of the electronic communication, and convert the evaluation information into numerical information or categorical information; and
calculate a priority for each of a plurality of electronic communications based on the evaluation information, and assign priority information to each electronic communication and updateably store the priority information in the storage device; and
determine, based on the priority information and the evaluation information, whether notification to a user is required, and generate display information indicating notification content and transmit the display information to the terminal; and
cause the terminal to visually display the display information and the electronic communication data so that the user can recognize the importance and the response necessity; and
acquire behavior history of the user regarding response operations or processing operations for the electronic communication, and update at least one of a generation condition of the prompt sentence and a calculation condition of the priority based on a relationship between the behavior history and the evaluation information.

### Supplementary 2

The system according to supplementary 1,
wherein the processor is configured to
perform transmission of the prompt sentence to the generative artificial intelligence model and acquisition of the analysis result from the generative artificial intelligence model via the external information processing interface using a communication protocol, and specify a structure and an output format of the analysis result in the prompt sentence so as to improve automatic extraction of the evaluation information and accuracy of calculation of the priority.

### Supplementary 3

The system according to supplementary 1,
wherein the processor is configured to
hold, in the storage device, a user-specific optimization model that uses the behavior history of the user and the priority information of the electronic communication as learning data, estimate, by the user-specific optimization model, an importance evaluation criterion and a response necessity evaluation criterion for each user, and adjust, based on an estimation result, contents of the prompt sentence and a determination condition of necessity of notification for each user.

### Application Example 2

### Supplementary 1

A system comprising a processor,
wherein the processor is configured to
generate a prompt sentence for a generative AI model in order to cause the generative AI model to determine an importance of information and a necessity of response, the prompt sentence embedding target text data to be analyzed,
input the prompt sentence to the generative AI model and obtain, from the generative AI model, analysis result data including at least the importance of the information, the necessity of response, deadline information, and summary information,
analyze the target text data by using a natural language processing technique to extract at least date-time information, monetary information, and sender information, and integrate the extracted information with the analysis result data to calculate an importance index and a response urgency index as numerical values,
acquire past operation history data of a user and cause a machine learning model to learn a relationship among the operation history data, the importance index, and the response urgency index so as to generate a user-specific importance evaluation model, and calculate a final importance score for each piece of information by using the user-specific importance evaluation model,
determine a notification timing based on the deadline information and the final importance score, and schedule a notification job,
generate a notification message based on the final importance score, the necessity of response, the deadline information, and the summary information, and transmit the notification message as a push notification to a terminal device via a communication network,
cause the terminal device to output the notification message as a visual display, and acquire operation data from the user including at least opening, replying, ignoring, importance correction, or completion designation with respect to the information, and use the operation data as the operation history data to provide feedback to the machine learning model, and receive a setting instruction sentence in natural language input by the user, input to the generative AI model a configuration prompt sentence including the setting instruction sentence to generate notification condition rules, and reflect the notification condition rules in the determination of the notification timing and in the generation of the notification message.

### Supplementary 2

The system according to supplementary 1,
wherein the processor is configured to
perform transmission and reception of the prompt sentence and the analysis result data with the generative AI model by using an application programming interface integration model, and execute importance evaluation and notification control according to the respective configurations of supplementary 1 also for electronic communication data received from an external information processing apparatus via the application programming interface integration model.

### Supplementary 3

The system according to supplementary 1,
wherein the processor is configured to
use the user-specific importance evaluation model and an emotion estimation model to enhance, based on contents of electronic communication data and a communication history of the user, at least part of a notification control function and an information search function, and provide the enhanced function as a paid option.

What is claimed is:

1. A system comprising:
circuitry configured to:
receive, via a packet-switched network, input data records each including at least a character string field and a temporal attribute field;
construct a structured prompt based on at least the character string field and the temporal attribute field, the structured prompt including an instruction portion that specifies a plurality of extraction tasks;
transmit the structured prompt to a generative neural network model via an application programming interface;
acquire, from the generative neural network model, inference result data including a priority score value, an action classification value, a temporal constraint datum, and a condensed representation datum;
compute a feature vector from the input data records and the inference result data, the feature vector including at least a sentiment index, a length index, and a classification index; and
generate output signal data based on the priority score value and the condensed representation datum, and transmit the output signal data to a terminal device via the packet-switched network.

2. The system according to claim 1, wherein the circuitry is further configured to:
transmit the character string field to an external information processing apparatus having a natural language processing function via the packet-switched network; and
acquire, from the external information processing apparatus, analysis result data including topic information, sentiment information, keyword information, and date-time expression information.

3. The system according to claim 2, wherein the circuitry is further configured to:
extract, from the analysis result data, the date-time expression information; and
convert the date-time expression information into the temporal constraint datum by resolving relative temporal expressions with respect to the temporal attribute field of the corresponding input data record.

4. The system according to claim 3, wherein the circuitry is further configured to:
compute the sentiment index based on at least a polarity value and a magnitude value included in the sentiment information; and
compute the classification index based on at least a categorical label assigned to the input data record by the external information processing apparatus.

5. The system according to claim 4, wherein the circuitry is further configured to:
determine the action classification value as one of a reply class, a task class, or a no-action class based on the feature vector; and
set an action-required flag for the input data record based on the determined action classification value.

6. The system according to claim 5, wherein the circuitry is further configured to:
accumulate behavior history data representing interactions of a user with the input data records, the behavior history data including at least a viewing event, a response event, a storage event, and a deletion event; and
update a user-specific machine learning model based on the behavior history data by computing an error between the priority score value and a target value inferred from the behavior history data and adjusting weight parameters of the user-specific machine learning model using gradient descent.

7. The system according to claim 6, wherein the circuitry is further configured to:
apply the user-specific machine learning model to adjust the priority score value into a personalized priority score value; and
generate the output signal data based on the personalized priority score value instead of the priority score value.

8. The system according to claim 7, wherein the circuitry is further configured to:
register, in a search platform, search index data including the input data records, the personalized priority score value, the action-required flag, the temporal constraint datum, and the condensed representation datum; and
in response to a query from the terminal device, retrieve candidate records from the search platform and re-rank the candidate records using the user-specific machine learning model.

9. The system according to claim 8, wherein the circuitry is further configured to:
provide, based on user attribute information indicating a subscription status of the user, a basic retrieval function to a first category of users and an extended retrieval function to a second category of users, the extended retrieval function including filtering by the personalized priority score value, the temporal constraint datum, and the action-required flag.

10. The system according to claim 9, wherein the circuitry is further configured to:
receive, from the terminal device, a natural-language query associated with a selected input data record;
construct an additional structured prompt including the natural-language query and content of the selected input data record; and
transmit the additional structured prompt to the generative neural network model and return a response to the terminal device.

11. The system according to claim 10, wherein the input data records comprise electronic message data acquired from a communication device, and the character string field includes at least a sender address, a subject text, and a body text.

12. The system according to claim 11, wherein the circuitry is further configured to:
parse header information and body content from the electronic message data;
normalize sender address, subject text, body text, and timestamp fields into a unified structured record; and
store the unified structured record in a storage device.

13. The system according to claim 12, wherein the circuitry is further configured to:
compute an urgency keyword count by scanning the body text for predetermined urgency expressions;
compute an interrogative marker count; and
include the urgency keyword count and the interrogative marker count in the feature vector.

14. The system according to claim 13, wherein the generative neural network model comprises a large language model, and the circuitry is further configured to:
set a temperature parameter of the large language model to a value that reduces randomness of output; and
parse the inference result data by extracting values from a constrained format specified in the instruction portion of the structured prompt.

15. The system according to claim 14, wherein the circuitry is further configured to:
transmit the output signal data to the terminal device as list information, the list information including, for each input data record, the personalized priority score value, the action-required flag, the temporal constraint datum, and the condensed representation datum; and
the terminal device caches the list information in a local memory structure and performs sorting and filtering operations locally based on the cached personalized priority score values.

16. The system according to claim 15, wherein the circuitry is further configured to:
determine a notification timing based on the temporal constraint datum and the personalized priority score value;
schedule a notification job; and
transmit a push notification including the condensed representation datum and the action classification value to the terminal device at the determined notification timing.

17. The system according to claim 16, wherein the circuitry is further configured to:
receive, from the terminal device, a natural-language setting instruction;
construct a configuration prompt including the natural-language setting instruction;
transmit the configuration prompt to the generative neural network model to generate notification condition rules; and
apply the notification condition rules to the determination of the notification timing.

18. A system comprising:
circuitry configured to:
receive, via a packet-switched network, input data records each including a character string field and a temporal attribute field;
transmit the character string field to an external information processing apparatus having a natural language processing function and acquire analysis result data including topic information, sentiment information, keyword information, and date-time expression information;
construct a structured prompt based on the character string field, the temporal attribute field, and at least a portion of the analysis result data, the structured prompt including an instruction portion that specifies extraction of a priority score value, an action classification value, a temporal constraint datum, and a condensed representation datum;
transmit the structured prompt to a generative neural network model via an application programming interface and acquire inference result data conforming to the instruction portion;
compute a feature vector from the input data records and the analysis result data, the feature vector including a sentiment index, a length index, a classification index, an urgency keyword count, and an interrogative marker count;
determine, using a trained classification model and the feature vector, the action classification value as one of a reply class, a task class, or a no-action class;
accumulate behavior history data of a user and update a user-specific machine learning model based on the behavior history data to generate a personalized priority score value; and
generate output signal data including the personalized priority score value, the action classification value, the temporal constraint datum, and the condensed representation datum, and transmit the output signal data to a terminal device via the packet-switched network.

19. The system according to claim 18, wherein the circuitry is further configured to:
register, in a search platform, search index data including the input data records, the personalized priority score value, and the temporal constraint datum; and
in response to a search query, retrieve candidate records from the search platform and re-rank the candidate records using the user-specific machine learning model to generate a personalized ranked result list.

20. A method performed by circuitry, the method comprising:
receiving, via a packet-switched network, input data records each including at least a character string field and a temporal attribute field;
constructing a structured prompt based on at least the character string field and the temporal attribute field, the structured prompt including an instruction portion that specifies a plurality of extraction tasks;
transmitting the structured prompt to a generative neural network model via an application programming interface;
acquiring, from the generative neural network model, inference result data including a priority score value, an action classification value, a temporal constraint datum, and a condensed representation datum;
computing a feature vector from the input data records and the inference result data, the feature vector including at least a sentiment index, a length index, and a classification index; and
generating output signal data based on the priority score value and the condensed representation datum, and transmitting the output signal data to a terminal device via the packet-switched network.
